(19) United States
(12) Patent Application Publication
(10) Pub. No.: US 2026/0231237 A1
(43) Pub. Date: Aug. 6, 2026

(54) METHODS, DEVICES, AND COMPUTER READABLE STORAGE MEDIUM FOR TWO-STAGE RANDOM ACCESS

(71) Applicant: Huawei Technologies Co., Ltd., Shenzhen (CN)

(72) Inventors: Aman Jassal, Stittsville (CA); Amine Maaref, Ottawa (CA); Jianglei Ma, Ottawa (CA)

(21) Appl. No.: 19/635,075

(22) Filed: Mar. 31, 2026

Related U.S. Application Data
(63) Continuation of application No. PCT/CN2024/082286, filed on Mar. 18, 2024.
(60) Provisional application No. 63/588,151, filed on Oct. 5, 2023.

(51) Int. Cl. H04W 74/0833

(52) U.S. Cl. CPC H04W 74/0833

(57) ABSTRACT

Example embodiments relate to methods, devices and a computer readable storage medium for two-stage RA. In an aspect, a first network device receives RA preambles from devices. The first network device transmits, based on the received RA preambles, a group RA request to a second network device. The group RA request indicating that the devices attempt to establish connections with the second network device.

### CROSS-REFERENCES TO RELATED APPLICATIONS

This application is a continuation of International Application No. PCT/CN2024/082286, filed on Mar. 18, 2024, which claims priority to U.S. Provisional Patent Application No. 63/588,151 filed on Oct. 5, 2023, the contents of which are incorporated herein by reference in its entirety.

### FIELD

Example embodiments of the present disclosure relate generally to wireless communications. Particularly, it relates to methods, devices, and computer readable storage medium for two-stage random access (RA).

### BACKGROUND

Wireless communications system such as fourth generation (4G) system (for example, Long-Term Evolution (LTE) system), fifth generation (5G) system (for example, New Radio (NR) system) have been deployed to provide various types of applications, such as message, voice, video and other data.

In NR, non-terrestrial networks (NTNs) are developed, which may utilize spaceborne vehicles such as satellites (including low earth orbiting (LEO) satellites, medium earth orbiting (MEO) satellites, geostationary earth orbiting (GEO) satellites as well as highly elliptical orbiting (HEO) satellites), or airborne vehicles (also called high-altitude platform) such as drones, or aircraft as a base station or relay for communications between different devices.

Either the satellites or the drones in NTNs may move at a high-speed relative to devices such as user equipments (UEs) operating within the NTN, which is different from the scenario between UE and ground-based base station. In addition, the distance between the UE and the satellites or the drones is also much longer than the distance between UE and ground-based base station.

Accordingly, solutions in NTNs, which may cooperate with terrestrial networks (TN), to provide communications with acceptable cost (such as power consumption and/or complexity) are desired.

### SUMMARY

In general, example embodiments of the present disclosure provide a solution for two-stage random access.

It is to be understood that the summary section is not intended to identify key or essential features of embodiments of the present disclosure, nor is it intended to be used to limit the scope of the present disclosure. Other features of the present disclosure will become easily comprehensible through the following description.

In a first aspect, there is provided a method performed by a first network device. The method comprises: receiving, at a first network device, RA preambles from devices; and transmitting, based on the received RA preambles, a group RA request to a second network device, the group RA request indicating that the devices attempt to establish connections with the second network device. In this way, power consumption of the devices due to sending uplink UL information may be reduced. In addition, the probability of missed detection of RA preambles by the second network device may be reduced.

In some implementations of the present disclosure, the method further comprises: receiving, from the devices, requests for establishing the connections; and transmitting a group connection setup request to the second network device, the group connection setup request comprising at least part of the requests received from the devices. In this way, it is more feasible for the first network device to process RA requests from the devices on the ground and also initiate or establish RRC connections for the devices.

In some implementations of the present disclosure, the method further comprises: determining a first plurality of random access channel (RACH) identities (IDs) based on at least one physical random access channel (PRACH) occasion in which the RA preambles were received. The group RA request comprises the first plurality of RACH IDs.

In some implementations of the present disclosure, the group RA request indicates at least one of the following: time when the RA preambles were received; types of the devices; whether a timing advance field is to be included in an RA response, wherein the RA response is to be received from the second network device; whether a frequency hopping field is to be included in the RA response; whether an uplink frequency resource allocation field is to be included in the RA response; whether an uplink time resource allocation field is to be included in the RA response; whether a modulation and coding scheme (MCS) field is to be included in the RA response; whether a Transmit Power Control (TPC) command is to be included in the RA response; whether a channel state information (CSI) request field is to be included in the RA response; whether a channel access cyclic prefix (CP) extension field is to be included in the RA response; whether an azimuth beam angle information (BAI) field is to be included in the RA response; whether a zenith BAI field is to be included in the RA response; or whether a temporary cell radio network temporary identifier (C-RNTI) field is to be included in the RA response.

In some implementations of the present disclosure, the method further comprises: obtaining a configuration for the group RA request.

In some implementations of the present disclosure, the configuration for the group RA request indicates at least one of the following: a time window for reception of the RA preambles; a period of the time window; a length of sequences of the RA preambles; time resources on which the RA preambles are to be received; frequency resources on which the RA preambles are to be received; whether time when the RA preambles were received is to be included in the group RA request; whether types of the devices is to be included in the group RA request; whether a timing advance request field is to be included in the group RA request; whether a frequency hopping field is to be included in the group RA request; whether an uplink frequency resource allocation field is to be included in the group RA request; whether an uplink time resource allocation field is to be included in the group RA request; whether a MCS field is to be included in the group RA request; whether a TPC command is to be included in the group RA request; whether a CSI request field is to be included in the group RA request; whether a channel access CP extension field is to be included in the group RA request; whether an azimuth BAI field is to be included in the group RA request; whether a zenith BAI field is to be included in the group RA request; or whether a temporary C-RNTI field is to be included in the group RA request.

In some implementations of the present disclosure, the group connection setup request comprises at least one of the following: a second plurality of IDs of the devices, or types of services that triggered establishment of the connections.

In some implementations of the present disclosure, the RA preambles are comprised in a first group of RA preambles which are associated with a non-terrestrial network.

In some implementations of the present disclosure, the first network device is included in a terrestrial network and the second network device is included in a non-terrestrial network.

In some implementations of the present disclosure, the first network device and the second network device are included in a non-terrestrial network.

In a second aspect, there is provided a method performed by a second network device. The method comprises: receiving a group RA request at a second network device from a first network device, the group RA request indicating that devices attempt to establish connections with the second network device; and transmitting an RA response to at least one of the devices. In this way, the probability of missed detection of RA preambles by the second network device may be reduced.

In some implementations of the present disclosure, the method further comprises: receiving a group connection setup request from the first network device, the group connection setup request comprising at least part of requests for establishing the connections which were transmitted by the devices; and transmitting a connection setup response to at least one of the devices.

In some implementations of the present disclosure, the group RA request comprises a first plurality of RACH IDs of the devices.

In some implementations of the present disclosure, the RA response comprises downlink control information scrambled with one of the first plurality of RACH IDs of the devices.

In some implementations of the present disclosure, the group RA request indicates at least one of the following: time when RA preambles were received by the first network device; types of the devices; whether a timing advance field is to be included in the RA response message; whether a frequency hopping field is to be included in the RA response message; whether an uplink frequency resource allocation field is to be included in the RA response message; whether an uplink time resource allocation field is to be included in the RA response message; whether a MCS field is to be included in the RA response message; whether a TPC command is to be included in the RA response message; whether a CSI request field is to be included in the RA response message; whether a channel access CP extension field is to be included in the RA response message; whether an azimuth BAI field is to be included in the RA response message; whether a zenith BAI field is to be included in the RA response message; or whether a temporary C-RNTI field is to be included in the RA response message.

In some implementations of the present disclosure, the method further comprises: transmitting, to the first network device, a configuration for the group RA request.

In some implementations of the present disclosure, the configuration for the group RA request indicates at least one of the following: a time window for reception of RA preambles; a period of the time window; a length of sequences of the RA preambles; time resources on which the RA preambles are to be received; frequency resources on which the RA preambles are to be received; whether time when the RA preambles were received is to be included in the group RA request; whether types of the devices is to be included in the group RA request; whether a timing advance request field is to be included in the group RA request; whether a frequency hopping field is to be included in the group RA request; whether an uplink frequency resource allocation field is to be included in the group RA request; whether an uplink time resource allocation field is to be included in the group RA request; whether a MCS field is to be included in the group RA request; whether a TPC command is to be included in the group RA request; whether a CSI request field is to be included in the group RA request; whether a channel access CP extension field is to be included in the group RA request; whether an azimuth BAI field is to be included in the group RA request; whether a zenith BAI field is to be included in the group RA request; or whether a temporary C-RNTI field is to be included in the group RA request.

In some implementations of the present disclosure, the group connection setup request comprises at least one of the following: a second plurality of IDs of the devices, or types of services that triggered establishment of the connections between the second network device and the devices.

In some implementations of the present disclosure, the first network device is included in a terrestrial network and the second network device is included in a non-terrestrial network.

In some implementations of the present disclosure, the first network device and the second network device are included in a non-terrestrial network.

In a third aspect, there is provided a method performed by a device. The method comprises: transmitting an RA preamble from a device to a first network device, wherein the RA preamble is comprised in a first group of RA preambles which are associated with a non-terrestrial network; receiving an RA response from a second network device; transmitting, to the first network device, a request for establishing a connection with the second network device; and receiving a connection setup response from the second network device. In this way, power consumption of the devices due to sending uplink UL information may be reduced.

In some implementations of the present disclosure, the RA response comprises downlink control information scrambled with a first ID of the device, the first ID being associated with the RA preamble.

In some implementations of the present disclosure, the method further comprises: obtaining information about a beam direction for transmitting the RA preamble; and transmitting the RA preamble comprises transmitting the RA preamble based on the information.

In some implementations of the present disclosure, the information about the beam direction comprises at least one of the following: an azimuth BAI, or a zenith BAI.

In a fourth aspect, there is provided a first network device. The first network device comprises a transceiver and a processor communicatively coupled with the transceiver. The processor is configured to: receive, at a first network device, RA preambles from devices; and transmit, based on the received RA preambles, a group RA request to a second network device, the group RA request indicating that the devices attempt to establish connections with the second network device.

In a fifth aspect, there is provided a second network device. The second network device comprises a transceiver and a processor communicatively coupled with the transceiver. The processor is configured to: receive a group RA request at a second network device from a first network device, the group RA request indicating that devices attempt to establish connections with the second network device; and transmit an RA response to at least one of the devices.

In a sixth aspect, there is provided a device. The device comprises a transceiver and a processor communicatively coupled with the transceiver. The processor is configured to: transmit an RA preamble from a device to a first network device, In some implementations of the present disclosure, the RA preamble is comprised in a first group of RA preambles which are associated with a non-terrestrial network; receive an RA response from a second network device; transmit, to the first network device, a request for establishing a connection with the second network device; and receive a connection setup response from the second network device.

In a seventh aspect, there is provided a non-transitory computer readable medium. The non-transitory computer readable medium comprises computer program stored thereon, the computer program, when executed on at least one processor, causing the at least one processor to perform the method of the first aspect, the second aspect, the third aspect, or any possible implementation of the first aspect, the second aspect or the third aspect.

In an eighth aspect, there is provided a chip. The chip comprises at least one processing circuit configured to perform the method of the first aspect, the second aspect, the third aspect, or any possible implementation of the first aspect, the second aspect or the third aspect.

In a ninth aspect, there is provided a system. The system comprises at least one first network device of the fourth aspect, at least one second network device of the fifth aspect and at least one device of the sixth aspect.

### BRIEF DESCRIPTION OF THE DRAWINGS

Some example implementations will now be described with reference to the accompanying drawings, in which:

FIG. 1 illustrates an example of a communication system in which some example implementations of the present disclosure may be implemented;

FIG. 2 illustrates a detailed example of the communication system of FIG. 1 in which some example implementations of the present disclosure may be implemented;

FIG. 3 illustrates an example of an electronics device and a base station in which some example implementations of the present disclosure may be implemented;

FIG. 4 illustrates example modules in a device or apparatus in which some example implementations of the present disclosure may be implemented;

FIG. 5 illustrates an example of a communication system with T-TRP and NT-TRP in which some example implementations of the present disclosure may be implemented;

FIG. 6 illustrates another example of a communication system with T-TRP and NT-TRP in which some example implementations of the present disclosure may be implemented;

FIG. 7 illustrates another example of a communication system with T-TRP and NT-TRP in which some example implementations of the present disclosure may be implemented;

FIG. 8 illustrates another example of a communication system with T-TRP and NT-TRP in which some example implementations of the present disclosure may be implemented;

FIG. 9 illustrates an example signaling chart of a communication process in which some example implementations of the present disclosure may be implemented;

FIG. 10 illustrates a signaling chart illustrating an example process for two-stage RA in accordance with some implementations of the present disclosure;

FIG. 11, FIG. 12 and FIG. 13 illustrate example scenarios in which some implementations of the present disclosure may be implemented;

FIG. 14 illustrates a signaling chart illustrating an example process for two-stage RA in accordance with some implementations of the present disclosure;

FIG. 15 illustrates a signaling chart illustrating an example process for two-stage RA in accordance with some implementations of the present disclosure;

FIG. 16 illustrates a signaling chart illustrating an example process for two-stage RA in accordance with some implementations of the present disclosure;

FIG. 17 illustrates an example of a method implemented at a first network device in which some example implementations of the present disclosure may be implemented;

FIG. 18 illustrates an example of a method implemented at a second network device in which some example implementations of the present disclosure may be implemented;

FIG. 19 illustrates an example of a method implemented at a device in which some example implementations of the present disclosure may be implemented;

FIG. 20 illustrates a block diagram of a device that may be used for implementing devices and methods in accordance with some implementations of the present disclosure;

FIG. 21 illustrates a schematic diagram of a structure of an apparatus in accordance with some implementations of the present disclosure;

FIG. 22 illustrates a schematic diagram of a structure of another apparatus in accordance with some implementations of the present disclosure; and

FIG. 23 illustrates a schematic diagram of a structure of a further apparatus in accordance with some implementations of the present disclosure.

Throughout the drawings, the same or similar reference numerals represent the same or similar elements.

### DETAILED DESCRIPTION

Principles of the present disclosure will now be described with reference to some example implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation”, “an implementation”, “an example implementation”, and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

The present disclosure encompasses various implementations, including not only method implementations, but also other implementations such as apparatus implementations and implementations related to non-transitory computer readable storage media. Implementations may incorporate, individually or in combinations, the features disclosed herein.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms. The words “first”, “second”, etc., when used before a same term (e.g., ED, or an operating step) does not mean an order or a sequence of the term. For example, the “first ED” and the “second ED”, means two different EDs without specially indicated, and similarly, the “first step” and the “second step” means two different operating steps without specially indicated, but does not mean the first step have to happen before the second step. The real order depends on the logic of the two steps.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

It should be noted that the message in the disclosure could be replaced with information, which may be carried in one single message, or be carried in more than one separate message.

Without special noting, the terms “apparatus” and “device” are used exchangeable, and the terms “identity” and “identifier” are used exchangeable.

The terms “coupled”, “coupling” or “connected” as used herein may have several different meanings depending on the context in which these terms are used. For example, as used herein, the terms coupled, coupling, or connected may indicate that two elements or devices are directly connected to one another or connected to one another through one or more intermediate elements or devices via a mechanical element depending on the particular context.

The term “receive”, “detect” and “decode” as used herein may have several different meanings depending on the context in which these terms are used. For example, without special note, the term “receive” may indicate that information (e.g., DCI, or MAC-CE, RRC signaling or TB) is received successfully by the receiving node, which means the receiving side correctly detect and decode it. In this scenario, “receive” may cover “detect” and “decode” or may indicates same thing, e.g., “receive paging” means decoding paging correctly and obtaining the paging successfully, accordingly, “the receiving side does not receive paging” means the receiving side does not detect and/or decoding the paging. “paging is not received” means the receiving side tries to detect and/or decoding the paging, but not obtain the paging successfully. The term “receive” may sometimes indicate that a signal arrives at the receiving side, but does not mean the information in the signal is detected and decoded correctly, then the receiving side need perform detecting and decoding on the signal to obtain the information carried in the signal. In this scenario, “receive”, “detect” and “decode” may indicate different procedure at receiving side to obtain the information.

When the functions are implemented in the form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the implementations of this application. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

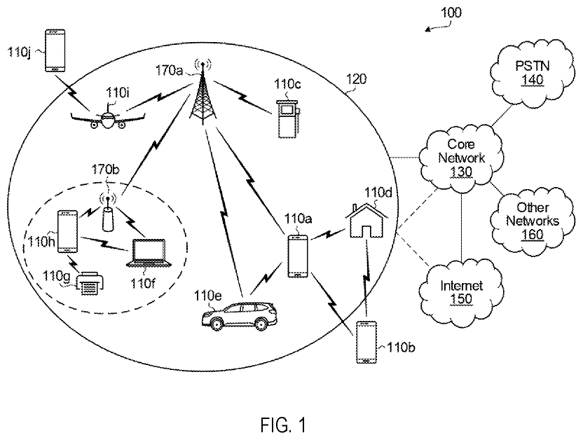

Referring to FIG. 1, as an illustrative example without limitation, a simplified schematic illustration of a communication system is provided. The communication system 100 (which may be a wireless system) comprises a radio access network 120. The radio access network (RAN) 120 may be a next generation (e.g. sixth generation (6G) or later) radio access network, or a legacy (e.g. 5G, 4G, 3G or 2G) radio access network. One or more communication electronic device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. The communication system 100 may also comprise a public switched telephone network (PSTN) 140, the internet 150, and other networks 160.

In general, the communication system 100 enables multiple wireless or wired elements to communicate data and other content. The communication system 100 may provide content, such as voice, data, video, and/or text, via broadcast, multicast, groupcast, unicast, etc. And the communication system 100 may provide a wide range of communication services and applications (such as earth monitoring, remote sensing, passive sensing and positioning, navigation and tracking, autonomous delivery and mobility, etc.)

The communication system 100 may operate by sharing resources, such as carrier spectrum bandwidth, between its constituent elements.

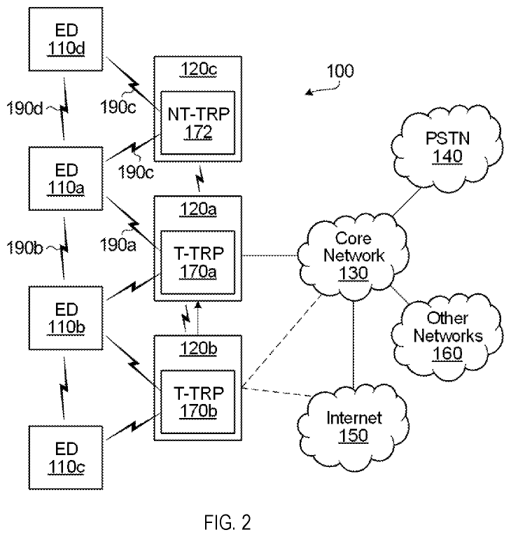

FIG. 2 illustrates more detailed example for the communication system 100. The communication system 100 may include a terrestrial communication system and/or a non-terrestrial communication system. The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. The heterogeneous network may achieve better overall performance through efficient multi-link joint operation, more flexible functionality sharing, and faster physical layer link switching between terrestrial networks and non-terrestrial networks. The terrestrial communication system and the non-terrestrial communication system could be considered sub-systems of the communication system.

Same as in the example shown in FIG. 1, in the example shown in FIG. 2, the communication system 100 may include ED 110a, 110b, 110c, 110d (generically referred to as ED 110), and RAN 120a, 120b. In addition, the communication system 100 may also include a non-terrestrial communication network 120c. The communication system 100 may also include one or more of a core network 130, a public switched telephone network (PSTN) 140, the Internet 150, and other networks 160. The RANs 120a, 120b include respective RAN nodes such as base stations (BSs) 170a, 170b, which may be generically referred to as terrestrial transmit and receive points (T-TRPs) 170a, 170b. In one implementations, the non-terrestrial communication network 120c includes a RAN node such as an access node (or base station) 172, which may be generically referred to as a non-terrestrial transmit and receive point (NT-TRP) 172. As may be surmised on the basis of similarity in reference numerals, the non-terrestrial communication network 120c may be considered to be a radio access network, with operational aspects in common with the RANs 120a, 120b. In another implementation, the non-terrestrial communication network 120c may include at least one non-terrestrial network (NTN) device and at least one corresponding terrestrial network device, wherein the at least one non-terrestrial network device works as a transport layer device and the at least one corresponding terrestrial network device works as a RAN node, which communicates with the ED via the non-terrestrial network device. In addition, there may be an NTN gateway in the ground (i.e., referred as a terrestrial network device) also as a transport layer device to communication with both the NTN device, and the RAN node communicates with the ED via the NTN device and the NTN gateway. In some implementations, the NTN gateway and the RAN node may be located in the same device.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, ED 110a may communicate an uplink (UL) and/or downlink (DL) transmission over a terrestrial air interface 190a with T-TRP 170a. In some examples, the EDs 110a, 110b, 110c, and 110d may also communicate directly with one another via one or more sidelink (SL) air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

In addition, the communication system 100 may comprising a sensing agent (not shown in the figure) to manage the sensed data from ED 110 and or the T-TRP 170 and/or NT-TRP 172. In one implementation, the sensing agent is located in the T-TRP 170 and/or NT-TRP 172. In another implementation, the sensing agent is a separate node which has interface to communicate with the core network 130 and/or the RAN 120 (e.g., the T-TRP 170 and/or NT-TRP 172).

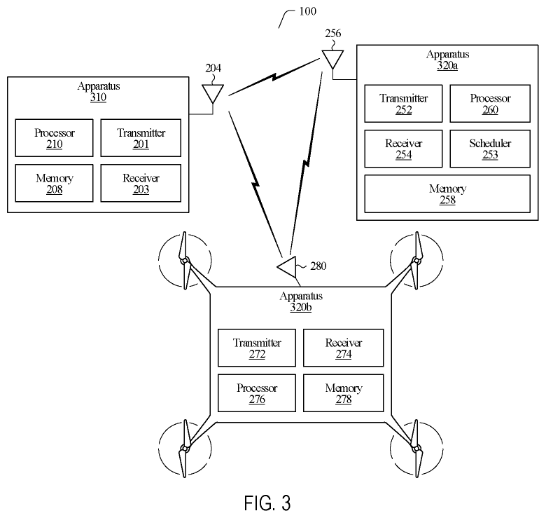

FIG. 3 illustrates an example of an Apparatus 310 wirelessly communicating with at least one of two apparatuses (e.g., Apparatus 320a and Apparatus 320b, referred as Apparatus 320) in a communication system, e.g., the communication system 100C, according to one implementation. The Apparatus 310 may be a UE (e.g., ED 110 in FIG. 1 or 2). The Apparatus 320a may be a terrestrial network device (e.g., T-TRP 170 as shown in FIG. 1 or 2), and Apparatus 320b may be a non-terrestrial network device (e.g., NT-TRP 172 as shown in FIG. 2). However, this is not necessary. For example, Apparatus 320a may be an NT-TRP, and 320b may be a T-TRP, both Apparatus 320a and 320b may be T-TRPs or NT-TRPs, according to present disclosure. In the following, the ED 110 as an example of the Apparatus 310 is described, and T-TRP 170 as an example of Apparatus 320a is described, and NT-TRP 172 as an example of Apparatus 320a is described. Although only one Apparatus 310, one Apparatus 320a and one Apparatus 320b are shown, please note that the number of Apparatus 310 (e.g. ED 110) could be one or more, and the number of Apparatus 320a and/or 320b could be one or more. For example, one ED 110 may be served by only one T-TRP 170 (or one NT-TRP 172), by more than one T-TRP 170, by more than one NT-TRP 172, or by one or more T-TRP 170 and one or more NT-TRP 172.

The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to but not limited to) as a user equipment/device (UE), a wireless transmit/receive unit (WTRU), a mobile station, a fixed or mobile subscriber unit, a cellular telephone, a station (STA), a MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the foregoing devices, among other possibilities. Future generation EDs 110 may be referred to using other terms. The base station 170a and 170b is a T-TRP and will hereafter be referred to as T-TRP 170. Also shown in FIG. 3, a non-terrestrial (NT) device will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

As shown in FIG. 3, the ED 110 includes at least one processor 210. Only one processor 210 is illustrated to avoid congestion in the drawing. The ED 110 may further include a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals. The ED 110 may include at least one memory 208. Only the transmitter 201, receiver 203, processor 210, memory 208, and antenna 204 is illustrated for simplicity, but the ED 110 may include one or more other components.

The memory 208 stores instructions. The memory 208 may also store data used, generated, or collected by the ED 110. For example, the memory 208 could store software instructions or modules configured to implement some or all of the functionality and/or implementations described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The processor 210 performs (or controls the ED 110 to perform) operations described herein as being performed by the ED 110. As illustrated below and elsewhere in the present disclosure, for example, the processor 210 performs or controls the ED 110 to perform receiving transport blocks (TBs), using a resource for decoding of one of the received TBs, releasing the resource for decoding of another of the received TBs, and/or receiving configuration information configuring a resource. In details, the operation may include those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Processing operations related to processing sidelink transmissions may include operations such as transmit/receive beamforming, modulating/demodulating and encoding/decoding symbols. Depending upon the implementation, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some implementations, the processor 210 implements the transmit beamforming and/or the receive beamforming based on the indication of beam direction, e.g. beam angle information, received from the T-TRP 170. In some implementations, the processor 210 may perform operations relating to network access (e.g. initial access) and/or downlink synchronization, such as operations relating to detecting a synchronization sequence, decoding and obtaining the system information, etc. In some implementations, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

In some implementations, the ED 110 may be an apparatus (also called component), for example, communication module, modem, chip, or chipset, it includes at least one processor 210, and an interface or at least one pin. In this scenario, the transmitter 201 and receiver 203 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or another ED 110 may be referred as transmitting information to the interface or at least one pin, or as transmitting information to the NT-TRP 172 and/or the T-TRP 170 and/or another ED 110 via the interface or at least one pin, and receiving information from the NT-TRP 172 and/or the T-TRP 170 and/or another ED 110 may be referred as receiving information from the interface or at least one pin, or as receiving information from the NT-TRP 172 and/or the T-TRP 170 and/or another ED 110 via the interface or at least one pin. The information may include control signaling and/or data.

As shown in FIG. 3, the T-TRP 170 include at least one processor 260. Only one processor 260 is illustrated to avoid congestion in the drawing. The T-TRP 170 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 may further include at least one memory 258. The T-TRP 170 may further include scheduler 253. Only the transmitter 252, receiver 254, processor 260, memory 258, antenna 256 and scheduler 253 are illustrated for simplicity, but the T-TRP may include one or more other components.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro base station (BS), a pico BS, a relay node, a donor node, or the like, or combinations thereof. The T-TRP 170 may refer to the foregoing devices or refer to apparatus (e.g. a communication module, a modem, or a chip) in the foregoing devices.

In some implementations, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some implementations, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some implementations, the T-TRP 170 may actually be a plurality of T-TRPs that are operating together to serve the ED 110, e.g. through the use of coordinated multipoint transmissions.

The processor 260 performs operations including those related to: preparing a transmission for downlink transmission to the ED 110, processing an uplink transmission received from the ED 110, preparing a transmission for backhaul transmission to the T-TRP 170 and/or NT-TRP 172, and processing a transmission received over backhaul from the T-TRP 170 and/or NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, etc. In some implementations, the processor 260 also generates an indication of beam direction which may be scheduled for transmission by a scheduler 253. The processor 260 performs other network-side processing operations described herein, such as determining the location of the ED 110, determining where to deploy the NT-TRP 172, etc. In some implementations, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as physical layer signaling such as downlink control information (DCI). Signaling transmitted in an uplink physical layer control channel may be known as physical layer signaling such as uplink control information (UCI). Signaling transmitted in a sidelink physical layer control channel may be known as physical layer signaling such as sidelink control information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to radio resource control (RRC) protocol signaling or media access control-control element (MAC-CE) signaling. Signaling may be included in a combination of physical layer signaling and higher layer signaling.

The scheduler 253 may be coupled to the processor 260 or integrated in the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources.

The memory 258 is configured to store information, and optionally data. The memory 258 stores instructions and data used, generated, or collected by the T-TRP 170. For example, the memory 258 could store software instructions or modules configured to implement some or all of the functionality and/or implementations described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

When the T-TRP 170 is an apparatus (also called as component, for example, communication module, modem, chip, or chipset in a device, it includes at least one processor, and an interface or at least one pin. In this scenario, the transmitter 252 and receiver 254 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or ED 110 may be referred as transmitting information to the interface or at least one pin, and receiving information from the NT-TRP 172 and/or the T-TRP 170 and/or ED 110 may be referred as receiving information from the interface or at least one pin. The information may include control signaling and/or data.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station.

As shown in FIG. 3, The T-TRP 170 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 may further include at least one memory 258. The T-TRP 170 may further include scheduler 253. Only the transmitter 252, receiver 254, processor 260, memory 258, antenna 256 and scheduler 253 are illustrated for simplicity, but the T-TRP may include one or more other components.

As shown in FIG. 3, the NT-TRP 172 includes at least one processor 276. Only one processor 276 is illustrated to avoid congestion in the drawing. The NT-TRP 172 may include a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 may further include at least one memory 278. The NT-TRP 172 may further include scheduler. Only the transmitter 272, receiver 274, processor 276, memory 278, antenna 280 are illustrated for simplicity, but the NT-TRP may include one or more other components.

The NT-TRP 172 include a processor 276 for performing operations including those related to: preparing a transmission for downlink transmission to the ED 110, processing an uplink transmission received from the ED 110, preparing a transmission for backhaul transmission to T-TRP 170 and/or another NT-TRP 172, and processing a transmission received over backhaul from the T-TRP 170 and/or another NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some implementations, the processor 276 implements the transmit beamforming and/or receive beamforming based on beam direction information received from the T-TRP 170. In some implementations, the processor 276 may generate signaling, e.g. to configure one or more parameters of the ED 110. In some implementations, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The memory 278 is configured to store information and optionally data. The memory 278 stores instructions and data used, generated, or collected by the NT-TRP 172. For example, the memory 278 could store software instructions or modules configured to implement some or all of the functionality and/or implementations described herein and that are executed by the processor 276.

Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some implementations, the NT-TRP 172 may actually be a plurality of NT-TRPs that are operating together to serve the ED 110, e.g. through coordinated multipoint transmissions.

When the NT-TRP 172 is an apparatus (e.g. communication module, modem, chip, or chipset) in a device, it includes at least one processor, and an interface or at least one pin. In this scenario, the transmitter 272 and receiver 274 may be replaced by the interface or at least one pin, wherein the interface or at least one pin is to connect the apparatus (e.g., chip) and other apparatus (e.g., chip, memory, or bus). Accordingly, the transmitting information to the T-TRP 170 and/or another NT-TRP 172 and/or ED 110 may be referred as transmitting information to the interface or at least one pin, and receiving information from the T-TRP 170 and/or another NT-TRP 172 and/or ED 110 may be referred as receiving information from the interface or at least one pin. The information may include control signaling and/or data.

Note that “transmit/receive point (TRP)”, as used herein, may refer to a T-TRP or a NT-TRP. A T-TRP may alternatively be called a terrestrial network TRP (“TN TRP”) and a NT-TRP may alternatively be called a non-terrestrial network TRP (“NTN TRP”). The T-TRP 170, the NT-TRP 172, and/or the ED 110 may include other components, but these have been omitted for the sake of clarity.

Note that “signaling”, as used herein, may alternatively be called control signaling, control message, control information, or message for simplicity. Signaling between a BS (e.g., the network node 170) and a terminal or sensing device (e.g., ED 110), or signaling between different terminal or sensing device (e.g., between ED 110i and ED 110j) may be carried in physical layer signaling (also called as dynamic signaling), which is transmitted in a physical layer control channel. For downlink the physical layer signaling may be known as downlink control information (DCI) which is transmitted in a physical downlink control channel (PDCCH). For uplink, the physical layer signaling may be known as uplink control information (UCI) which is transmitted in a physical uplink control channel (PUCCH). For sidelink, signaling between different terminal or sensing device (e.g., between ED 110i and ED 110j) may be known as sidelink control information (SCI) which is transmitted in a physical sidelink control channel (PSCCH). Signaling may be carried in a higher-layer (e.g., higher than physical layer) signaling, which is transmitted in a physical layer data channel, e.g. in a physical downlink shared channel (PDSCH) for downlink signaling, in a physical uplink shared channel (PUSCH) for uplink signaling, and in a physical sidelink shared channel (PSSCH) for sidelink signaling. Higher-layer signaling may also called static signaling, or semi-static signaling. Higher-layer signaling may be radio resource control (RRC) protocol signaling or media access control-control element (MAC-CE) signaling. Signaling may be included in a combination of physical layer signaling and higher layer signaling.

It should be noted that in present disclosure, “information”, when different from “message”, may be carried in one single message, or be carried in more than one separate message.

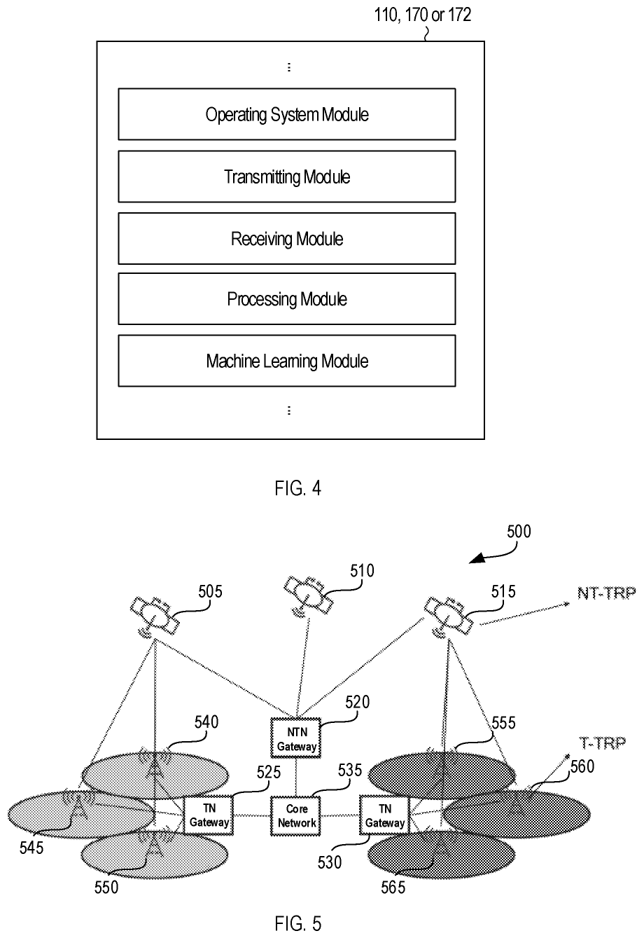

One or more steps of the implementation methods provided in this disclosure may be performed by corresponding units or modules, according to FIG. 4. FIG. 4 illustrates units or modules in a device or apparatus, such as in the ED 110, in the T-TRP 170, or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170, and the NT-TRP 172 are known to those of skill in the art. As such, these details are omitted here.

Network power saving is expected to become an important feature in the context of future 6G systems and in the scenario of integrated terrestrial and non-terrestrial systems.

The present invention is aimed at devices such as UEs, IoT devices, robots, cars, etc. The type of network scenarios envisioned may include terrestrial TRPs such as base-stations and/or non-terrestrial TRPs such as drones, balloons, high-altitude platform stations (HAPS), satellites, and any such devices that support radio access technologies such as 5G NR, future 6G or other technologies.

A scenario is assumed where terrestrial TRPs are communicating with non-terrestrial TRPs that are part of a satellite constellation. FIG. 5 illustrates an example of a communication system 500 with T-TRP and NT-TRP in which some example implementations of the present disclosure may be implemented. In the communication system 500, a satellite constellation comprises a plurality of satellite orbits, such that the earth is always provided with wireless coverage from the satellites. Each satellite orbit may have a plurality of satellites such as satellites or NT-TRPs 505, 510, and 515 in it. Terrestrial TRPs such as T-TRPs 540, 545, 550, 555, 560, and 565 may be connected to the core network 535 through terrestrial Gateways (TN Gateway) such as 525, 530 while satellite constellations may be connected to the core network 535 through dedicated non-terrestrial Gateway (NTN Gateway) 520, as shown in FIG. 5. Devices such as UEs may connect and communicate with a T-TRP 540, 545, 550, 555, 560, or 565 or with a NT-TRP 505, 510, or 515, depending on the conditions of traffic load, radio link quality, congestion, and so on. The NT-TRPs 505, 510, and 515 can be implementations of the NT-TRP 172 in FIGS. 1, 2, and 3. The T-TRPs 540, 545, 550, 555, 560, and 565 can be implementations of the T-TRP 170 in FIGS. 1, 2, and 3.

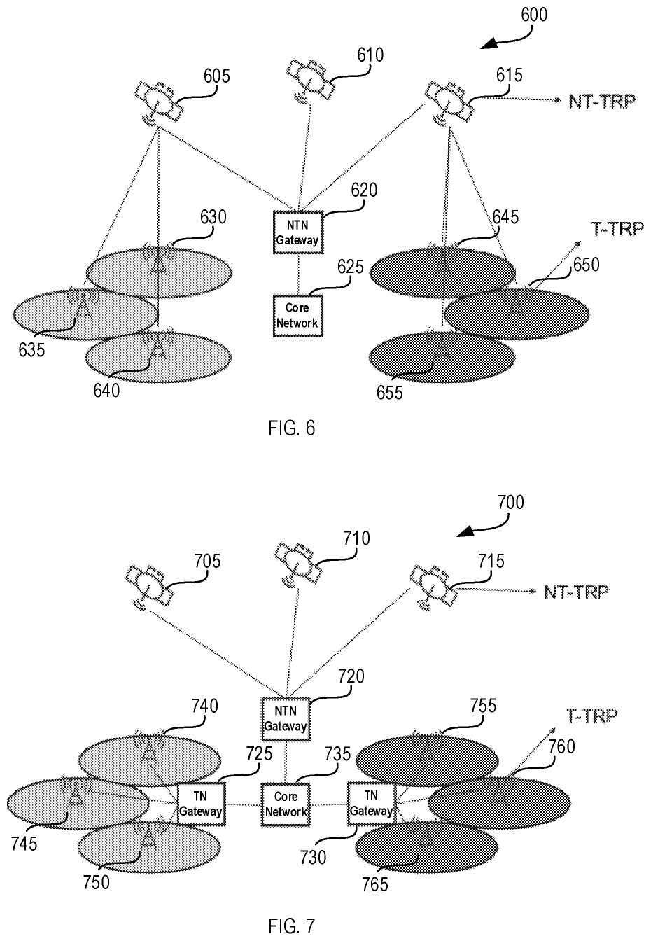

Another scenario may be envisioned where the satellite constellation effectively acts as the Gateway for terrestrial TRPs on the ground. FIG. 6 illustrates another example of a communication system 600 with T-TRP and NT-TRP in which some example implementations of the present disclosure may be implemented. In the scenario of the communication system 600, the satellite constellation with satellites 605, 615 effectively acts as the gateway for terrestrial TRPs 630, 635, 640 and 645, 650, 655 on the ground. Satellites 605, 610, and 615 in the satellite constellation communicate with the core network 625 through NTN gateway 620 located on the ground using a wireless link, while the NTN gateway 620 on the ground use a wired link (e.g. fiber optical link) to communicate with the core network 625. Terrestrial TRPs 630, 635, 640 and 645, 650, 655 communicate with satellites 605 and 615 using a wireless link and satellites communicate between each-other using free space optical links, such as using lasers. Devices such as UEs may connect and communicate with a T-TRP 630, 635, 640, 645, 650, or 655 or with a NT-TRP 605, 610, or 615, depending on the conditions of traffic load, radio link quality, congestion, and so on. The NT-TRPs 605, 610, and 615 can be implementations of the NT-TRP 172 in FIGS. 1, 2, and 3. The T-TRPs 630, 635, 640 and 645, 650, 655 can be implementations of the T-TRP 170 in FIGS. 1, 2, and 3.

Another scenario may be envisioned where the non-terrestrial TRPs communicate with terrestrial TRPs through the core network. FIG. 7 illustrates another example of a communication system 700 with T-TRP and NT-TRP in which some example implementations of the present disclosure may be implemented. In the scenario of the communication system 700, the non-terrestrial TRPs 705, 710, and 720 communicate with terrestrial TRPs 740, 745, 750, 755, 760, and 765 through the core network 735. Non-terrestrial TRPs 705, 710, and 720 may first communicate with dedicated non-terrestrial gateway 720, which then communicate with the core network 735. The core network 735 may then relay the power saving commands from non-terrestrial TRPs 705, 710, and 720 to terrestrial TRPs 740, 745, 750, 755, 760, and 765 via dedicated terrestrial gateways 725 and 730. Devices such as UEs may connect and communicate with a T-TRP 740, 745, 750, 755, 760, or 765 or with a NT-TRPs 705, 710, or 715, depending on the conditions of traffic load, radio link quality, congestion, and so on. The NT-TRPs 705, 710, and 715 can be implementations of the NT-TRP 172 in FIGS. 1, 2, and 3. The T-TRPs 740, 745, 750, 755, 760, and 765 can be implementations of the T-TRP 170 in FIGS. 1, 2, and 3.

For illustrative purposes, specific example implementations will now be explained in greater detail in conjunction with the figures and above mentioned system, ED and TRP.

The implementations set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

In traditional cellular systems such as 5G NR, the UE can receive, detect and measure reference signals such as SS/PBCH blocks and NZP-CSI-RS. Such reference signals are based on pseudo random noise (PRN) binary sequences such as Gold sequences and those sequences may be initialized using common or UE-specific scrambling identities. As an example, primary synchronization signal (PSS) and secondary synchronization signal (SSS) sequences are initialized using the physical cell identity (PCI) value, which is a common scrambling identity. NZP-CSI-RS sequences are initialized using UE-specific scrambling identities, which are configured by the network to the UE.

5G NR Release 17 (Rel-17) introduces support for non-terrestrial networks by introducing several enhancements on the timing relationships for the Timing Advance, the reference timing for channel state information (CSI) resources, the transmission timing of DCIs scheduling PUSCH, the transmission timing of Random Access response carried by a physical uplink shared channel (PUSCH), the transmission timing of hybrid automatic repeat request-acknowledgement (HARQ-ACK) on a physical uplink control channel (PUCCH).

In 5G NR Rel-17, NTN support was introduced allowing UEs to support DL/UL communication with satellites using the so-called “bent-pipe” scenario, where a ground station transmits signals towards satellites in space, and satellites reflect signals back to UEs on the ground. Dedicating signaling related to NTN was introduced in order to assist UEs with NTN operation. Higher-layer signaling such as RRC introduces signaling satellite ephemeris, satellite position, satellite signal polarization, timing advance offsets, satellite System Information Block (SIB), satellite epochs in order to support NTN operation. Other features that were introduced were the extension of HARQ processes to 32 in order to accommodate for large propagation delay scenarios and the disabling of HARQ-ACK feedback.

5G NR Rel-17 also introduces a solution combining closed-loop and open-loop Timing Advance compensation, where the closed-loop part is controlled by the network and the open-loop part is carried out by the UE. The compensation from the UE may be based on the knowledge of the satellite's ephemeris (e.g. parameters such as the satellite's orbital angles).

5G NR Rel-17 supports so-called “bent-pipe” scenarios, i.e. the base-station is located behind an NTN gateway on the ground, the NTN gateway sends a transmission towards the satellite (this link is called the “feeder” link) and the satellite transmits the transmission towards UEs on the ground (this link is called the “service” link).

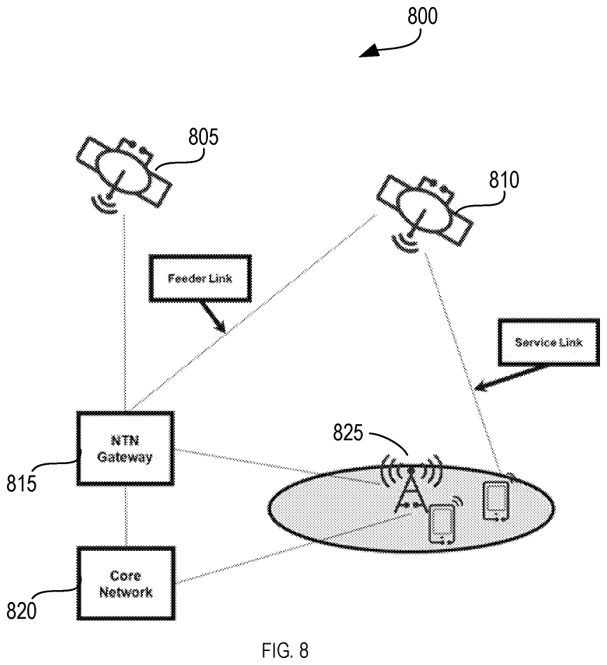

FIG. 8 illustrates an example of a communication system 800 with T-TRP and NT-TRP in which some example implementations of the present disclosure may be implemented. In the communication system 800, NT-TRPs 805 and 810 in the satellite constellation communicate with the core network 820 through NTN gateway 815 located on the ground using a wireless link. The T-TRP 825 is located behind an NTN gateway 815 on the ground. The NTN gateway 815 sends a transmission towards the NT-TRPs 805 and 810 using a “feeder” link and the NT-TRP 805 or 810 transmits the transmission towards UEs on the ground using a “service” link. The NT-TRPs 805 and 810 can be an implementation of the NT-TRP 172 in FIGS. 1, 2, and 3. The T-TRP 825 can be implementations of the T-TRP 170 in FIGS. 1, 2, and 3.

In 5G NR Release 18 (Rel-18), NTN support was further enhanced to introduce coverage enhancements for NTN, network-verified UE location, as well as support TN to NTN and NTN to NTN mobility scenarios. Satellites transmit multiple beams towards the ground and each beam may be associated with a given “physical cell identity”. In addition, the satellites transmit beams in a “fixed” manner, where “fixed” means that the satellite isn't steering its beams towards a given direction, instead the beams “slide” on the surface of Earth and thus appear to be “moving” from the perspective of devices on the ground.

The support introduced in 5G NR Rel-17 for NTN is based on a non-transparent design in the sense that every satellite is effectively seen by devices such as UEs, IoT devices, cars, etc., as a serving cell. Devices are also made aware of the satellite's ephemeris as well as the satellite's position at any given time as the satellite explicitly broadcasts it within System Information Block 19 (SIB19), which is transmitted by satellites in order to assist devices such as UEs with assistance information for NTN access (i.e., the UEs access to the NTN and to be served by the NTN). This results in a non-transparent radio access design which prevents smooth integration of transmit diversity schemes, multi-TRP transmission schemes and distributed satellite systems.

In the case of Low Earth Orbit (LEO) NTN access, satellites are constantly in movement and therefore are in line-of-sight to devices on the ground for a limited amount of time. Taking the Starlink constellation as an example, a LEO satellite may be in line-of-sight of a given device on the ground for a duration in order of several minutes. As a result, any information that the satellite transmits or broadcasts to devices on the ground becomes outdated within a few minutes and constantly needs to be updated in order for the satellite communication to be working (due to ever changing Timing Advance for Uplink synchronization, and the need to (re-)acquire Downlink synchronization). This results in high signaling overhead between satellites and devices on the ground just to keep the communication link operational.

LEO satellites use the fixed-beam model in order to transmit signals and channels towards devices on the ground. This results in satellite beams “sliding” across the surface of Earth, which triggers mobility and handover procedures whenever devices are located at the edge between two beams. Mobility and handover procedures may cause delays and interruptions as the RRC connection needs to be re-established upon entering the target cell, which hurts the overall user experience.

RA procedure may be another potential bottleneck in communication systems. There may be several millions of devices on the ground within a given coverage area, if these several million devices were to attempt RA within a short time interval, it may not be conceivable or feasible for NT-TRPs to be able to detect individual RA preambles transmitted by so many devices within this short time interval. This is because of the prohibitively high complexity this would incur on NT-TRPs. NT-TRPs are ultimately embedded systems and they may not be able to do the processing related to receiving, detecting and measuring so many RA preambles within such a short time interval.

In view of the above, a method is provided in the present disclosure. The feature of two-stage RA is introduced in the present disclosure. Random access procedure could be a part of the initial access procedure, whereby devices acquire downlink and uplink synchronization with the network. RA procedure may be used by devices to acquire the timing advance (which is received in the RA response) and to send the RRC connection request message (which is also known as “Message 3”).

Given that devices such as UEs, IoT devices, cars, etc., may be embedded systems with limited battery power, it is not reasonable to expect such devices to be sending information in the UL towards NT-TRPs such as e.g. satellites because the transmission power that would be required in order for e.g. UEs to operate at would drain the battery tremendously quickly. In the present disclosure, devices such as UEs may send their UL information (e.g., RA preambles) towards T-TRPs that are located within the coverage area where the UEs are located. In this way, the T-TRPs may act as a “collector” of RA requests (e.g., RA preambles) transmitted by the UEs. These T-TRPs then transmit an RA message on behalf of those UEs towards NT-TRPs such as e.g. satellites. The first stage of this RA procedure consists in UEs sending e.g. RA preambles towards T-TRPs. The second stage of this RA procedure consists in T-TRPs sending e.g. RA message towards an NT-TRP.

There may be several benefits from using such two-stage Random Access procedure. The first benefit is that it allows devices on the ground to transmit RA preambles towards devices that are closer to them and thus: reduce power consumption due to sending UL information. The second benefit is that this RA scheme may reduce the probability of missed detection of RA preambles by NT-TRPs: T-TRPs located within a given coverage area may transmit one RA message on behalf of e.g. several thousand devices, this may make it more feasible for NT-TRPs to process RA requests from devices on the ground and also initiate or establish e.g. RRC connections for these devices.

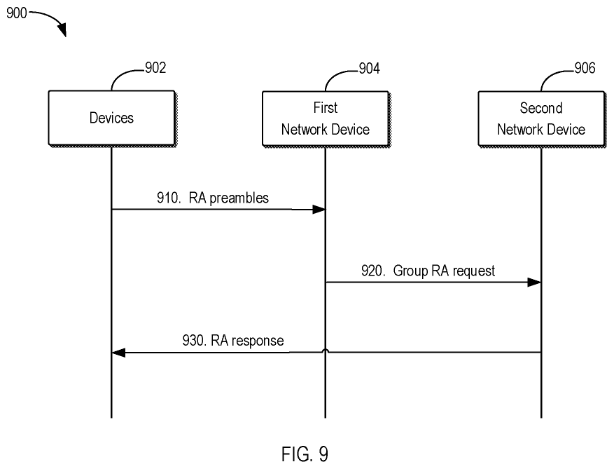

FIG. 9 illustrates a signaling chart illustrating an example process 900 for two-stage RA in accordance with some implementations of the present disclosure. The process 900 may involve devices 902, a first network device 904 and a second network device 906.

In some implementations, the devices 902 may be implemented as the EDs 110 in FIG. 1 or 2. For example, the devices 902 may be implemented as UEs, IoT devices, robots, or cars.

In some implementations, the first network device 904 may be included in a TN. In such implementations, the first network device 904 may be implemented as the T-TRP 170 in FIG. 1 or 2, or the T-TRP 540, 545, 550, 555, 560 or 565 in FIG. 5, or the T-TRP 630, 635, 640, 645, 650 or 655 in FIG. 6, or the T-TRP 740, 745, 750, 755, 760 or 765 in FIG. 7, or the T-TRP 825 in FIG. 8.

Alternatively, in some implementations, the first network device 904 may be included in an NTN. In such implementations, the first network device 904 may be implemented as the NT-TRP 172 in FIG. 2, or the NT-TRP 505, 510 or 515 in FIG. 5, or the NT-TRP 605, 610 or 615 in FIG. 6, or the NT-TRP 705, 710 or 715 in FIG. 7, or the NT-TRP 805 or 810 in FIG. 8.

In some implementations, the second network device 906 may be included in an NTN. In such implementations, the second network device 906 may be implemented as the NT-TRP 172 in FIG. 2, or the NT-TRP 505, 510 or 515 in FIG. 5, or the NT-TRP 605, 610 or 615 in FIG. 6, or the NT-TRP 705, 710 or 715 in FIG. 7, or the NT-TRP 805 or 810 in FIG. 8.

As shown in FIG. 9, the devices 902 transmits 910 RA preambles to the first network device 904.

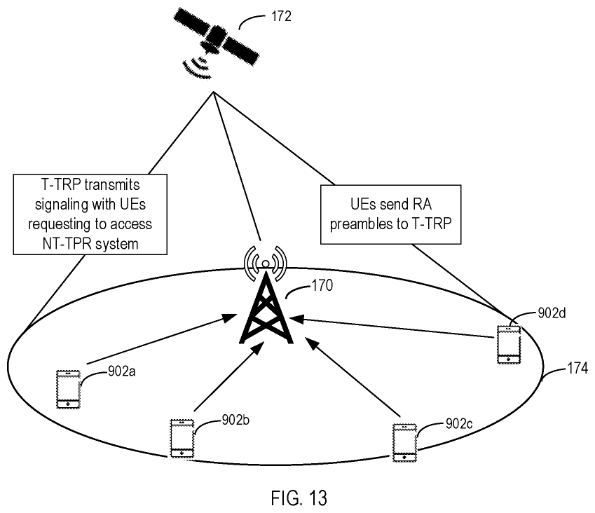

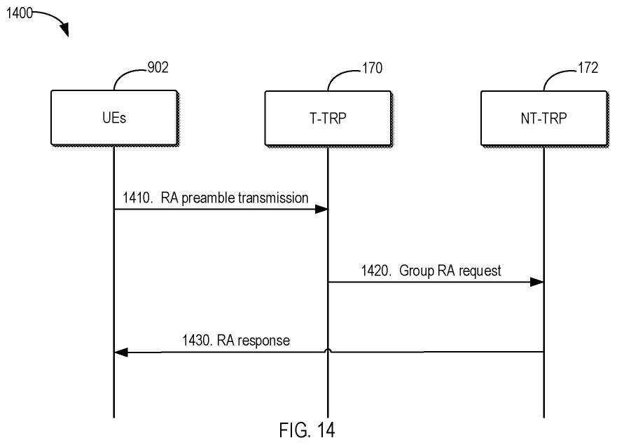

In some implementations, the RA preambles may be included in a first group of RA preambles which are associated with an NTN. Details of such implementations will be described later with reference to FIG. 14.

Upon receiving the RA preambles from the devices 902, the first network device 904 transmits 920, based on the received RA preambles, a group RA request to the second network device 906. The group RA request indicates that the devices 902 attempt to establish connections with the second network device 906. Accordingly, the second network device 906 receives the group RA request from the first network device 904.

The second network device 906 transmits 930 an RA response to at least one of the devices 902.

With the process 900, the devices 902 transmit the RA preambles to the first network device 904. In this way, the first network device 904 may act as a “collector” of the RA preambles transmitted by the devices 902. The first network device 904 then transmits the group RA request on behalf of the devices 902 to the second network device 906. Thus, a two-stage RA procedure may be achieved. The first stage of the two-stage RA procedure may comprise that the devices 902 transmit the RA preambles to the first network device 904. The second stage of the two-stage RA procedure may comprise that the first network device 904 transmits the group RA request on behalf of the devices 902 to the second network device 906.

There may be several benefits from using such a two-stage RA procedure. The first benefit is that it allows the devices 902 on the ground to transmit RA preambles towards devices that are closer to them and thus to reduce power consumption due to sending uplink UL information. The second benefit is that the two-stage RA procedure may reduce the probability of missed detection of RA preambles by the second network device 906. The first network device 904 located within a given coverage area may transmit the group RA request on behalf of several thousand devices, which may make it more feasible for the first network device 904 to process RA requests from the devices 902 on the ground and also initiate or establish RRC connections for the devices 902.

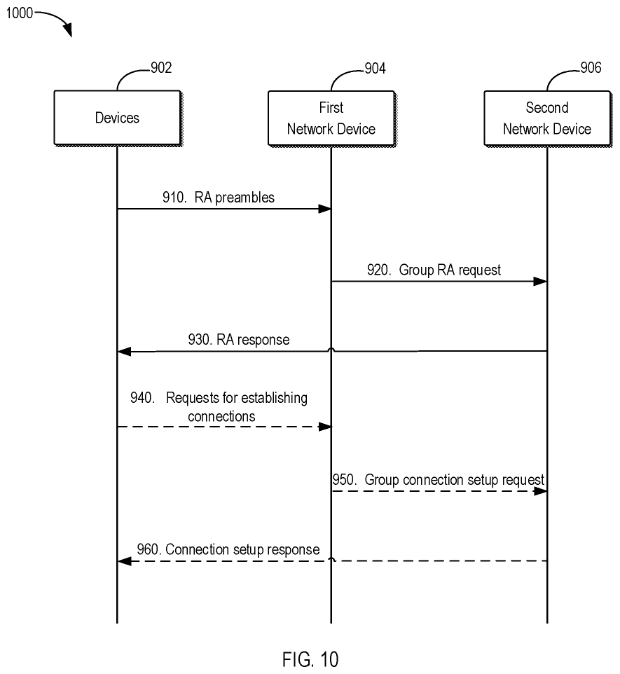

FIG. 10 illustrates a signaling chart illustrating an example process 1000 for two-stage RA in accordance with some implementations of the present disclosure. The process 1000 may be considered as an example implementation of the process 900. The process 1000 may involve the devices 902, the first network device 904 and the second network device 906.

The actions 910, 920 and 930 in the process 1000 are the same as those in the process 900. Details of these actions are omitted for brevity.

The process 1000 are different from the process 900 in actions 940, 950 and 960.

Specifically, as shown in FIG. 10, upon receiving the RA response, the devices 902 may transmit 940, to the first network device 904, requests for establishing the connections with the second network device 906.

In some implementations, the devices 902 may want to establish RRC connections with the second network device 906. In such implementations, the devices 902 may transmit the requests for establishing the connections by transmitting RRC connection setup requests to the first network device 904.

Upon receiving the requests for establishing the connections with the second network device 906, the first network device 904 may transmit 950 a group connection setup request to the second network device 906. The group connection setup request may comprise at least part of the requests received from the devices 902.

In some implementations, the first network device 904 may receive the RRC connection setup requests from the devices 902. In such implementations, the first network device 904 may transmit a group RRC connection setup request to the second network device 906 so that the RRC connections may be established between the devices 902 and the second network device 906.

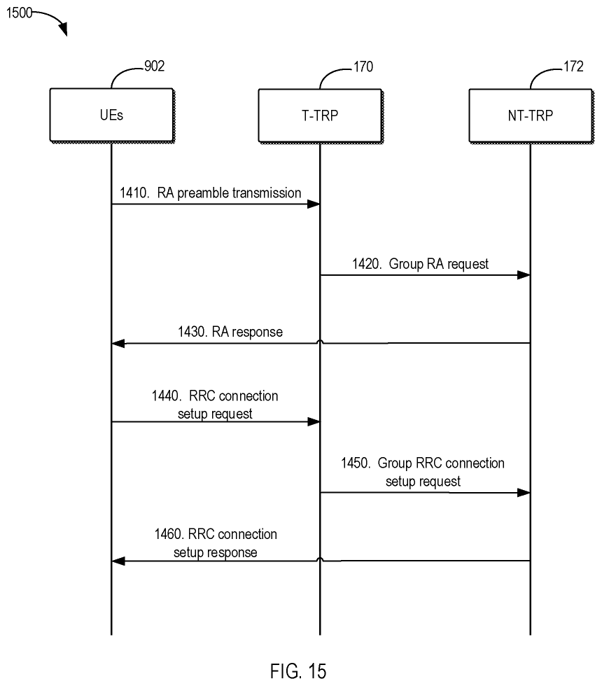

In some implementations, the group connection setup request may comprises at least one of the following: a second plurality of IDs of the devices 902, or types of services that triggered establishment of the connections with the second network device 906. This will be described later with reference to FIG. 15.

In some implementations, the second plurality of IDs of the devices 902 may comprise Temporary Mobile Subscriber Identities (TMSIs) of the devices 902. Each of the TMSIs may include a random value.

Upon receiving the group connection setup request, the second network device 906 may transmit 960 a connection setup response to at least one of the devices 902.

In some implementations, the second network device 906 may receive the group RRC connection setup request from the first network device 904. In such implementations, the second network device 906 may transmit an RRC connection setup response to at least one of the devices 902.

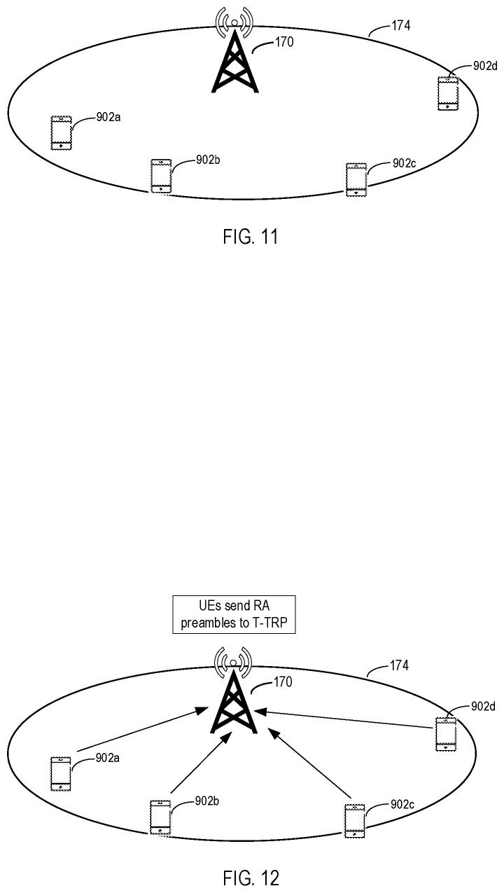

Hereinafter, some example scenarios in which some implementations of the present disclosure may be implemented will be described with reference to FIGS. 11 to 16.

FIG. 11, FIG. 12 and FIG. 13 illustrate example scenarios in which some implementations of the present disclosure may be implemented. The example scenarios of FIGS. 11 and 12 may involve the devices 902 and the first network device 904 in FIG. 9 or 10. The example scenario of FIG. 13 may involve the devices 902, the first network device 904 and the second network device 906 in FIG. 9 or 10.

In the example scenarios of FIG. 11, FIG. 12 and FIG. 13, the devices 902 are implemented as UEs 902a, 902b, 902c and 902d (generically referred to as UEs 902 or individually referred to as a UE 902), and the first network device 904 is implemented as the T-TRP 170 in FIG. 1 or 2. In the example scenario of FIG. 13, the second network device 906 is implemented as the NT-TRP 172 in FIG. 2.

As illustrated in FIG. 11, there is a coverage area 174 on the ground and the UEs 902 are within this coverage area 174.

In the context of the present disclosure, we assume that the UEs 902 are not connected to the network, i.e., the UEs 902 may be in a power mode associated with sleeping or in idle mode or turned off. In the context of the example scenarios of FIGS. 11, 12 and 13, we also assume that the coverage area 174 includes one or more T-TRPs and these one or more terrestrial TRPs have a connection with one or more NT-TRPs operating in a non-terrestrial system (e.g. a satellite mega-constellation). The example scenarios of FIGS. 11, 12 and 13 will be described by taking the T-TRP 170 as an example of the one or more T-TRPs, and the NT-TRP 172 as an example of the one or more NT-TRPs.

In order to connect with an NTN such as e.g. a satellite mega-constellation, the UEs 902 may steer their beams towards the sky, however there may be lots of NT-TRPs such as satellites that are in line-of-sight of the UEs 902. Therefore, there may be potentially lots of NT-TRPs a UE 902 could establish a connection with. However, there may be a problem in terms of the transmission power requirement from the UEs 902, i.e., they may not have sufficient transmission power in order to transmit a signal that would be able to reach the NT-TRP 172 such as a satellite. Another problem may be the huge number of devices that may attempt to establish a connection with the NT-TRP 172 simultaneously, which may cause tremendous interference at the NT-TRP 172 such multiple UEs 902 that are very far from each-other may send an RA preamble on the same time or frequency resources.

In order to address such issues, a two-stage RA procedure may be used. The first stage of the two-stage RA procedure may comprise that the UEs 902 transmits RA preambles towards the T-TRP 170, with the T-TRP 170 acting as a “collector” on behalf of the UEs 902 on the ground. The second stage of the two-stage RA procedure may comprise that the T-TRP 170 transmits a group RA request to the NT-TRP 172.

The UEs 902 on the ground may attempt to perform initial access with an NTN. For example, the UEs 902 may attempt to perform initial access by transmitting RA preambles.

In some implementations, the RA preamble sequence length for NTNs may be different than that of TNs. As an example, RA preamble sequence lengths of {1500, 1750, 2000} are associated with operation in NTNs whereas RA preamble sequence lengths of {139, 571, 839, 1151} are associated with operation in TNs. RA preamble sequence equations may be based on so-called Zadoff-Chu sequences, as shown in equations (1) and (2) below:

$${x}_{u , v} ( n ) = {x}_{u} ( ( n + {C}_{v} ) mod {L}_{RA} ) \qquad ( 1 )$$

$${x}_{u} ( i ) = {e}^{- j \frac{π ui ( i + 1 )}{{L}_{RA}}} , i = \{ 0 , 1 , … , {L}_{RA} - 1 \} \qquad ( 2 )$$

where xᵤ denotes a Zadoff-Chu sequence, a length of the sequence is given by L_{RA}, a cyclic shift is given by Cᵥ, a sequence number is given by u. The frequency-domain representation may be generated as follows:

$${y}_{u , v} ( n ) = {\sum }_{m = 0}^{{L}_{RA} - 1} {x}_{u , v} ( m ) \cdot {e}^{- j \frac{2 π mn}{{L}_{RA}}} \qquad ( 3 )$$

The UEs 902 may transmit RA preamble sequences with a length of {1500, 1750, 2000} in order to indicate that they would like to establish connections with an NTN. Upon transmitting an RA preamble sequence, the UE 902 may start a timer (e.g. the RA timer) in order to wait for an RA response while the RA timer is running.

In some implementations, the UEs 902 may transmit the RA preambles on at least one physical random access channel (PRACH) occasion. The T-TRP 170 may determine a first plurality of RACH identities (IDs) based on the at least one PRACH occasion in which the RA preambles were received. The group RA request may comprise the first plurality of RACH IDs.

In some implementations, the first plurality of RACH IDs may include but are not limited to random access radio network temporary identifiers (RA-RNTIs). Hereinafter, some implementations of the present disclosure will be described by taking RA-RNTIs as an example of the first plurality of RACH IDs. In such implementations, this group RA request may include e.g. the RA-RNTIs of devices that transmitted RA preambles within a given duration, this would indicate to the NT-TRP 172 which devices are waiting to receive a Random Access response from the network.

In some implementations, one PRACH occasion is associated with one RACH ID (e.g., RA-RNTI). Two or more than two different devices may have the same RA-RNTI. In other words, an RA-RNTI may not be specific to any particular device.

Let us take the example of two UEs. For example, as shown in FIG. 11, the UEs 902a and 902d are located in the same cell, but otherwise totally different locations. The UEs 902a and 902d may use exactly the same PRACH occasion and PRACH resource to transmit their respective RA preambles, which would result in the same RA-RNTI. Thus, the same RA-RNTI may be associated with two different UEs. It is possible that the group RA request comprise the same value of the RA-RNTI multiple times.

The UE 902 may expect to receive the RA response while the RA preambles are transmitted within specific time or frequency resources that map to so-called PRACH occasions, and the T-TRP 170 attempts to receive, detect and decode those RA preambles, as shown in the FIG. 12.

Based on the PRACH occasion in which the RA preambles were transmitted, the T-TRP 170 may derive a corresponding RA-RNTI associated with the device that transmitted the RA preamble. As shown in FIG. 13, four devices (e.g., the UEs 902a, 902b, 902c and 902d) transmit RA preambles and the RA preambles are detected by the T-TRP 170, the T-TRP 170 may transmit a group RA request to the NT-TRP 172 carrying the four devices' RA-RNTI. This group RA request may be e.g. a higher-layer signaling message such as RRC or media access control control element (MAC CE), an example is shown below:

groupRARequest = {
raRntiList = {579, 714, 802, 1233, 1259}
}

where “raRntiList” represents a RA-RNTI list field. The RA-RNTI list field comprises RA-RNTIs. For example, the RA-RNTI list field may comprise RA-RNTIs for five devices.

In some implementations, the T-TRP 170 may determine or derive an RA-RNTI associated with a PRACH occasion in which at least one RA preamble is transmitted based on an equitation (4) as below:

$$RA - RNTI = 1 + s\_id + 14 \times t\_id + 14 \times 80 \times f\_id + 14 \times 80 \times 8 \times ul\_carrier \_id \qquad ( 4 )$$

where s_id represents an index of the first OFDM symbol of the PRACH occasion (0≤s_id<14), t_id represents an index of the first slot of the PRACH occasion in a system frame (0≤t_id<80), where the subcarrier spacing to determine t_id is based on the value of μ for μ={0, 1, 2, 3}, and for μ={5, 6}, t_id represents an index of the 120 kHz slot in a system frame that contains the PRACH occasion (0≤t_id<80), f_id represents an index of the PRACH occasion in the frequency domain (0≤f_id<8), and ul_carrier_id represents a UL carrier used for RA preamble transmission (0 for NUL carrier, and 1 for SUL carrier).

The T-TRP 170 may act as a “collector” on behalf of the devices that transmitted RA preambles. The group RA request may include a field denoted as “raRntiList” which contains the RA-RNTIs of each of the UEs 902 that transmitted an RA preamble that was detected by the T-TRP 170.

In some implementations, the group RA request may additionally include a time-stamp associated with each RA-RNTI. In such implementations, the group RA request may include a field denoted as “raTimeStampList” which contains the time-stamp associated with an RA-RNTI. In other words, the group RA request may indicates time when the RA preambles were received. An example of the group RA request is shown as below:

```
groupRARequest = {
  raRntiList = {579, 714, 802, 1233, 1259},
  raTimeStampList = {4, 7, 11, 15, 17}
}
```

where “raTimeStampList” represents an RA time-stamp list field. The RA time-stamp list field contains the time-stamp associated with an RA-RNTI. In some implementations, there may be a one-to-one association between a time-stamp and an RA-RNTI, where e.g. the first RA-RNTI value in “raRntiList” is associated with the first time-stamp value in “raTimeStampList”, the second RA-RNTI value in “raRntiList” is associated with the second time-stamp value in “raTimeStampList”, etc. The time-stamp may be given as a time-slot index within an RA preamble reception window of time-slots. We may assume that T-TRPs attempt to detect RA preambles within a given time window, expressed in units of e.g., slots, mini-slots, OFDM symbols, groups of orthogonal frequency division multiplexing (OFDM) symbols. Alternative units of time that may be considered are seconds, milli-seconds, micro-seconds, nano-seconds, etc. As an example, the first value in “raTimeStampList” in the example above is “4”, which may mean that the RA-RNTI value “579” was detected by the T-TRP 170 in the fourth slot of the RA preamble reception window. The second value in “raTimeStampList” in the example above is “7”, which may mean that the RA-RNTI value 714″ was detected by the T-TRP 170 in the seventh slot of the RA preamble reception window.

In some implementations, the group RA request may additionally include a UE type field which may indicate the type of the device 902 (e.g. a UE, an IoT device, a robot, a car, etc.).

In some implementations, the group RA request may additionally include a timing advance request field which may indicate whether the timing advance field is to be included in the RA response.

In some implementations, the group RA request may additionally include a frequency hopping field which may indicate whether the frequency hopping field is to be included in the RA response.

In some implementations, the group RA request may additionally include a PUSCH frequency resource allocation field which may indicate whether the PUSCH frequency resource allocation is to be included in the RA response. In such implementations, the group RA request may indicate whether an uplink frequency resource allocation field is to be included in the RA response.

In some implementations, the group RA request may additionally include a PUSCH time resource allocation field which may indicate whether the PUSCH time resource allocation is to be included in the RA response. In such implementations, the group RA request may indicate whether an uplink time resource allocation field is to be included in the RA response.

In some implementations, the group RA request may additionally include a modulation and coding scheme (MCS) field which may indicate whether the MCS field is to be included in the RA response.

In some implementations, the group RA request may additionally include a transmit power control (TPC) command for PUSCH field which may indicate whether the TPC command for the PUSCH field is to be included in the RA response.

In some implementations, the group RA request may additionally include a channel state information (CSI) request field which may indicate whether the CSI request field is to be included in the RA response.

In some implementations, the group RA request may additionally include a channel access cyclic prefix (CP) extension field which may indicate whether the channel access CP extension field is to be included in the RA response.

In some implementations, the group RA request may additionally include an azimuth beam angle information (BAI) field which may indicate whether the azimuth BAI field is to be included in the RA response.

In some implementations, the group RA request may additionally include a zenith BAI field which may indicate whether the zenith BAI field is to be included in the RA response.

In some implementations, the group RA request may additionally include a temporary cell radio network temporary identifier (C-RNTI) field which may indicate whether the temporary C-RNTI is to be included in the RA response.

An example of the group RA request is shown below:

```
groupRARequest = {
  raRntiList = {579, 714, 802, 1233, 1259},
  raTimeStampList = {4, 7, 11, 15, 17},
  timingAdvanceList = {true, true, true, true, true},
  freqHoppingList = {false, false, false, true, true},
  puschFreqAllocList = {true, true, true, true, true},
  puschTimeAllocList = {true, true, true, true, true},
  mcsList = {false, false, false, false, false},
  tpcCommandList = {true, true, true, false, false},
  csiReqList = {false, false, false, false, false},
  azimuthBAIList = {false, false, false, false, false},
  zenithBAIList = {true, true, true, true, true}
}
```

In the above example, “timingAdvanceList” represents the Timing Advance request field. Each of bits in “timingAdvanceList” may indicate whether the timing advance field for a device 902 is to be included in the RA response. For example, a bit set to “true” may indicate that the timing advance field for the device 902 is to be included in the RA response, and the bit set to “false” may indicate that the timing advance field for the device 902 is not to be included in the RA response.

“FreqHoppingList” represents the frequency hopping field. Each of bits in “freqHoppingList” may indicate whether the frequency hopping field for a device 902 is to be included in the RA response. For example, a bit set to “true” may indicate that the frequency hopping field for the device 902 is to be included in the RA response, and the bit set to “false” may indicate that the frequency hopping field for the device 902 is not to be included in the RA response.

“PuschFreqAllocList” represents the PUSCH frequency resource allocation field. Each of bits in “puschFreqAllocList” may indicate whether the PUSCH frequency resource allocation for a device 902 is to be included in the RA response. For example, a bit set to “true” may indicate that the PUSCH frequency resource allocation for the device 902 is to be included in the RA response, and the bit set to “false” may indicate that the PUSCH frequency resource allocation for the device 902 is not to be included in the RA response.

“PuschTimeAllocList” represents the PUSCH time resource allocation field. Each of bits in “puschTimeAllocList” may indicate whether the PUSCH time resource allocation for a device 902 is to be included in the RA response. For example, a bit set to “true” may indicate that the PUSCH time resource allocation for the device 902 is to be included in the RA response, and the bit set to “false” may indicate that the PUSCH time resource allocation for the device 902 is not to be included in the RA response.

“McsList” represents the MCS field. Each of bits in “mcsList” may indicate whether the MCS field is to be included in the RA response. For example, a bit set to “true” may indicate that the MCS field for a device 902 is to be included in the RA response, and the bit set to “false” may indicate that the MCS field for the device 902 is not to be included in the RA response.

“TpcCommandList” represents the TPC command for PUSCH field. Each of bits in “tpcCommandList” may indicate whether the TPC command for PUSCH field is to be included in the RA response. For example, a bit set to “true” may indicate that the TPC command for PUSCH field for a device 902 is to be included in the RA response, and the bit set to “false” may indicate that the TPC command for PUSCH field for the device 902 is not to be included in the RA response.

“CsiReqList” represents the CSI request field. Each of bits in “csiReqList” may indicate whether the CSI request field is to be included in the RA response. For example, a bit set to “true” may indicate that the CSI request field for a device 902 is to be included in the RA response, and the bit set to “false” may indicate that the CSI request field for the device 902 is not to be included in the RA response.

“AzimuthBAIList” represents the azimuth BAI field. Each of bits in “azimuthBAIList” may indicate whether the azimuth BAI field is to be included in the RA response. For example, a bit set to “true” may indicate that the azimuth BAI field for a device 902 is to be included in the RA response, and the bit set to “false” may indicate that the azimuth BAI field for the device 902 is not to be included in the RA response.

“ZenithBAIList” represents the zenith BAI field. Each of bits in “zenithBAIList” may indicate whether the zenith BAI field is to be included in the RA response. For example, a bit set to “true” may indicate that the zenith BAI field for a device 902 is to be included in the RA response, and the bit set to “false” may indicate that the zenith BAI field for the device 902 is not to be included in the RA response.

In some implementations, the T-TRP 170 may obtain a configuration for the group RA request. For example, the T-TRP 170 may obtain the configuration for the group RA request from the core network 130 or an NT-TRP or other network node, e.g., operations, administration and maintenance (OAM).

In some implementations, the configuration for the group RA request may indicate at least one of the following: a time window for reception of the RA preambles, a period of the time window, a length of sequences of the RA preambles.

Alternatively or additionally, the configuration for the group RA request may indicate whether time when the RA preambles were received is to be included in the group RA request. For example, the configuration for the group RA request may indicate a time-stamp of each detected RA preamble is to be included in the group RA request.

Alternatively or additionally, the configuration for the group RA request may indicate whether an RRC connection is to be established.

As an example, the T-TRP 170 may have been configured by the core network 130 or the NT-TRP 172 to detect RA preambles sent by the UEs 902 that are attempting to do RA with an NT-TRP. An example of such higher-layer configuration (e.g. RRC) is shown as below:

```
groupRAConfiguration = {
  raWindow = {40slots},
  raSequenceLength = {1500},
  raRequestPeriod = {40slots},
  includeTimeStamp = {true},
  setupRRCConnection = {true}
}
```

The above example of higher-layer configuration allows the T-TRP 170 to monitor for RA preambles transmitted by the UEs 902 within a window of 40 slots, the T-TRP 170 monitors for RA preambles whose sequence length is set to 1500, the periodicity of the RA window is also set to 40 slots and the T-TRP 170 is configured to include the time-stamp of each detected RA preamble in the group RA request. The T-TRP 170 may also include e.g. a one-bit field indicating to the NT-TRP 172 that for each UE 902 whose RA-RNTI is included, the NT-TRP 172 may establish an RRC connection so that the UE 902 can transition towards connected mode (or equivalently a power mode where the UE 902 can run functions for communication purposes). Other examples and behaviors may be contemplated and envisioned.

In some implementations, the configuration for the group RA request may indicate at least one of the following: time resources on which the RA preambles are to be received, or frequency resources on which the RA preambles are to be received.

As an example, the T-TRP 170 may be configured by e.g. the core network 130 or the NT-TRP 172 or other network node e.g., OAM, with the following higher-layer signaling (e.g. RRC):

```
groupRAConfiguration = {
  rachOccasionStartingSubframe = {4, 9, 14, 19},
  rachSubcarrierSpacing = {1.25 kHz, 15kHz, 60 kHz}, -------- Optional
}
```

The above higher-layer configuration may be interpreted as follows: if the parameters “rachOccasionStartingSubframe” and “rachSubcarrierSpacing” are present, then the T-TRP may collect RA preambles that are detected within RACH occasions whose time and frequency resources coincide with that provided in “rachOccasionStartingSubframe” and/or “rachSubcarrierSpacing”. The parameter “rachOccasionStartingSubframe” may provide the starting subframe numbers within which the T-TRP 170 may be expected to receive and detect RA preambles from UEs 902. In this example, the T-TRP 170 receives and detects RA preambles starting in subframes {4, 9, 14, 19}. Similarly the parameter “rachSubcarrierSpacing” may provide the subcarrier spacing used for generating an RA preamble, in this example, the T-TRP 170 receives and detects RA preambles using a subcarrier spacing of {1.25 kHz, 5 kHz, 15 kHz}. It should be noted that PRACH occasions may span multiple consecutive slots depending on the RA preamble format.

Alternatively or additionally, the configuration for the group RA request may indicate whether types of the devices 902 is to be included in the group RA request.

Alternatively or additionally, the configuration for the group RA request may indicate whether a timing advance request field is to be included in the group RA request.

Alternatively or additionally, the configuration for the group RA request may indicate whether a frequency hopping field is to be included in the group RA request.

Alternatively or additionally, the configuration for the group RA request may indicate whether an uplink frequency resource allocation field is to be included in the group RA request.

Alternatively or additionally, the configuration for the group RA request may indicate whether an uplink time resource allocation field is to be included in the group RA request.

Alternatively or additionally, the configuration for the group RA request may indicate whether an MCS field is to be included in the group RA request.

Alternatively or additionally, the configuration for the group RA request may indicate whether a TPC command is to be included in the group RA request.

Alternatively or additionally, the configuration for the group RA request may indicate whether a CSI request field is to be included in the group RA request.

Alternatively or additionally, the configuration for the group RA request may indicate whether a channel access CP extension field is to be included in the group RA request.

Alternatively or additionally, the configuration for the group RA request may indicate whether an azimuth BAI field is to be included in the group RA request.

Alternatively or additionally, the configuration for the group RA request may indicate whether a zenith BAI field is to be included in the group RA request. or

Alternatively or additionally, the configuration for the group RA request may indicate whether a temporary C-RNTI field is to be included in the group RA request.

Upon receiving, detecting and decoding the group RA request, the NT-TRP 172 may transmit an RA response to at least one of the UEs 902 that attempted to do RA. The UEs 902 may be expecting an RA response from the NTN within a time duration.

In some implementations, the RA response may comprise downlink control information (DCI) scrambled with an ID of the UE 902. The ID may be associated with the RA preamble transmitted by the UE 902.

An example the RA response may be a physical downlink control channel (PDCCH) carrying a DCI format scrambled with the RA-RNTI associated with the RA preamble that the UE 902 transmitted to the T-TRP 170. Upon detecting a DCI format scrambled with the RA-RNTI associated with the RA preamble, the UE 902 may consider to have received the RA response.

The communication process in the example scenarios of FIG. 11, FIG. 12 and FIG. 13 may be summarized in a signaling chart shown in FIG. 14.

FIG. 14 illustrates a signaling chart illustrating an example process 1400 for two-stage RA in accordance with some implementations of the present disclosure. The process 1400 may be considered as an example implementation of the process 900. The process 1400 may involve the UEs 902 and the T-TRP 170 in FIG. 11, FIG. 12 and FIG. 13 as well as the NT-TRP 172 in FIG. 13.

As shown in FIG. 14, the UEs 902 transmits 1410 RA preambles to the T-TRP 170.

In some implementations, the UEs 902 may be provided with additional information to assist the UEs 902 in transmitting RA preambles.

In some implementations, the additional information may comprise information about a beam direction for transmitting the RA preambles. In such implementations, the UEs 902 may obtain the information about the beam direction for transmitting the RA preambles. In turn, the UEs 902 may transmit the RA preamble based on the information.

As an example, the UEs 902 may be provided with an Azimuth and/or Zenith BAI from its higher layers (e.g. from Non Access Stratum) so that the UEs 902 can steer their transmit beam towards the angular direction corresponding to the Azimuth and/or Zenith BAI. This may be beneficial as it may help the UE 902 steer it's transmit beam towards where the T-TRP 170 is and it may help the T-TRP 170 with detecting the RA preamble.

In some implementations, based on above mentioned implementations, two groups of RA preambles are defined. A first group of RA preambles are associated with NTN operation (i.e., the UE performs the RA procedure to a NT-TRP, e.g., the NT-TRP 172) and a second group of RA preambles are associated with TN operation (i.e., the UE performs the RA procedure to a T-TRP, e.g., the T-TRP 170). In details, the T-TRPs may be configured such that the first group of RA preambles, which are transmitted in RACH occasions that are associated with “NTN operation”, are to be “collected” by the T-TRP so that it transmits them to the NT-TRP on behalf of those UEs. Conversely, the second group of RA preambles, which are transmitted in RACH occasions that are associated with “TN operation”, are to be handled by the T-TRP, i.e., the T-TRP (e.g., the T-TRP 170) is the TRP that will send the RA response.

Similarly to above mentioned, the UEs 902 transmit RA preambles based on Zadoff-Chu sequences. In addition, the T-TRP 170 has been configured by e.g. the core network 130 or the NT-TRP about collecting RA preambles that are received within specific RACH occasions and send a group RA request for those UEs whose RA preambles were received within those specific RACH occasions. That is, the first group of RA preambles associated with the specific RACH occasions, and the second group of RA preambles associated with other RACH occasions different from the specific RACH occasions.

In some implementations, the first group of RA preambles and the second group of RA preambles are separated with different frequency resources, and/or different preambles, and/or different time resources.

By using different group of RA preamble, the RA preambles can be used flexibly and the T-TRP can handle the random access procedure correctly.

Upon receiving the RA preambles from the UEs 902, the T-TRP 170 transmits 1420, based on the received RA preambles, a group RA request to the NT-TRP 172. The group RA request indicates that the UEs 902 attempt to establish connections with the NT-TRP 172. Accordingly, the NT-TRP 172 receives the group RA request from the T-TRP 170.

The NT-TRP 172 transmits 1430 an RA response to at least one of the UEs 902.

In some implementations, after receiving RA preambles in the specific RA occasion, the T-TRP 170 may transmit the group RA request to the NT-TRP 172, and the NT-TRP 172 may then transmit an RA response to each UE 902 on the ground.

In some implementations, more than one T-TRPs may be present in the coverage area 174 and therefore: more than one T-TRP may send a group RA request to the NT-TRPs.

In some implementations, the more than one T-TRPs may transmit a group RA request to different NT-TRPs that are part of the same NTN (e.g. satellite mega-constellation).

In some implementations, the RA response from the NT-TRP 172 may also be treated as an acknowledgement of RRC connection setup with the UE 902.

FIG. 15 illustrates a signaling chart illustrating an example process 1500 for two-stage RA in accordance with some implementations of the present disclosure. The process 1500 may be considered as an example implementation of the process 1000 or 1400. The process 1500 may involve the UEs 902 and the T-TRP 170 in FIG. 11, FIG. 12 and FIG. 13 as well as the NT-TRP 172 in FIG. 13.

The actions 1410, 1420 and 1430 in the process 1500 are the same as those in the process 1400. Details of these actions are omitted for brevity.

The process 1500 are different from the process 1400 in actions 1440, 1450 and 1460.

Specifically, as shown in FIG. 15, following reception of the RA response, the UE 902 may send 1440 an RRC connection setup request. Assuming that the RA response includes an indication of UL resources to use in order to transmit an RRC connection setup request, the UE 902 may send an RRC connection setup request to the T-TRP 170. It should be noted that the PUSCH time and/or frequency resources that may be signaled in the RA response transmitted by the NT-TRP 172 may be used by the UE 902 for transmitting an RRC connection setup request towards the T-TRP 172. This RRC connection setup request may then be sent by the T-TRP to the NT-TRP 172 as part of a group RRC connection request. The RRC connection setup request may include fields such as e.g. the UE identity (which is unique to the UE 902), and the reason for establishing a connection. Upon receiving RRC connection setup requests from these UEs 902, the T-TRP 170 may again send 1450 a group RRC connection setup request to the NT-TRP 172 so that an RRC connection may be established between the UEs 902 and the NT-TRP 172. The group RRC connection setup request may be a higher-layer signaling (e.g. RRC) which looks like the following:

```
groupRRCRequest = {
  ueIdentityList = {120398234, 9182341923, 502894381, 7123819402, 3290817420},
  establishmentCauseList = {voiceCall, data, data, voiceCall, emergency}
}
```

The group RRC connection setup request (i.e., “groupRRCRequest”) may include a field called the “ueIdentityList” which includes the list of the unique UE identities of the UEs 902 that attempted to do RA. The UE identity may be e.g. the UE's TMSI and may include a random value.

The group RRC connection setup request may also include a field called the “establishmentCauseList” which includes the list of causes for each UE 902. The establishment cause may be a set of values e.g. “emergency”, “voiceCall”, “data”, “videoCall”, “sms”, etc., indicating the type of service that triggered RA. There may be a one-to-one association between a value in “ueIdentityList” and a value in “establishmentCauseList”. For example, the first UE identity value “120398234” may be associated with the first establishment cause value “voiceCall”, and so on.

Upon receiving the group RRC connection setup request, the NT-TRP 172 may transmit 1460 an RRC connection setup response to at least one of the UEs 902.

With the process 1500, a two-stage RA procedure may be achieved. There may be several benefits from using such a two-stage RA procedure. The first benefit is that it allows devices on the ground to transmit RA preambles towards devices that are closer to them and thus: reduce power consumption due to sending UL transmissions. The second benefit is that this RA scheme may reduce the probability of missed detection of RA preambles by NT-TRPs: T-TRPs located within a given coverage area may transmit one RA message on behalf of e.g. several thousand devices, this may make it more feasible for NT-TRPs to process RA requests from devices on the ground and also initiate or establish e.g. RRC connections for these devices.

In some implementations, the coverage area 174 includes a first set of one or more NT-TRP such as e.g. drones or HAPS and these one or more NT-TRP have a connection with a second set of one or more NT-TRPs operating in the non-terrestrial system (e.g. a satellite mega-constellation).

In some implementations, the group RA request message may include a field indicating the type of the device that initiated the Random Access procedure, where the field may be denoted as e.g. “deviceType” and its value may indicate that the device is e.g. a UE, a Reduced Capability UE (or equivalently a RedCap UE), a vehicle, a drone, an IoT UE, a smart-meter, a wearable device, etc.

In some implementations, the group RRC request may include a field indicating the type of the device that initiated the Random Access procedure, where the field may be denoted as e.g. “deviceType” and its value may indicate that the device is e.g. a UE, a Reduced Capability UE (or equivalently a RedCap UE), a vehicle, a drone, an IoT UE, a smart-meter, a wearable device, etc.

In some implementations, the RA preamble transmitted by a device such as e.g. a UE may implicitly indicate the type of the device (e.g. a UE). As an example, RA preambles may be split into “sets” or “groups” which may be implicitly associated with a type of device. Thus upon detection of an RA preamble, the T-TRP 170 or NT-TRP that detected the RA preamble may indicate to the NT-TRP 172 the type of the device that transmitted the RA preamble by including e.g. a field indicating the type of the device that initiated the Random Access procedure in the group RA request message.

In some implementations, the RA preamble transmitted by a device such as e.g. a UE may implicitly indicate the type of the device (e.g. a UE). As an example, RA preambles may be split into “sets” or “groups” which may be implicitly associated with a type of device. Thus upon detection of an RA preamble, the T-TRP 170 or NT-TRP that detected the RA preamble may indicate to the NT-TRP 172 the type of the device that transmitted the RA preamble by including e.g. a field indicating the type of the device that initiated the Random Access procedure in the group RRC request message.

In some implementations, the NT-TRP 172 may configure a T-TRP 170 with different RA preambles groups, where each individual RA preamble group may be associated with different types of devices. Upon detection of an RA preamble that belongs to one of the RA preamble groups, the T-TRP may assume that the device that transmitted the RA preamble is of the type that is associated with the corresponding RA preamble group.

In some implementations, the NT-TRP 172 may configure a NT-TRP with different RA preambles groups, where each individual RA preamble group may be associated with different types of devices. Upon detection of an RA preamble that belongs to one of the RA preamble groups, the NT-TRP may assume that the device that transmitted the RA preamble is of the type that is associated with the corresponding RA preamble group.

For example, the T-TRP 170 in FIG. 13, FIG. 14 and FIG. 15 may be replaced by another NT-TRP (referred as NT-TRP 176, and accordingly, the NT-TRP in FIG. 13, FIG. 14 and FIG. 15 is referred as NT-TRP 172) such as e.g. drones or balloons or HAPS that are located at some altitude within the coverage area 174 where the UEs 902 are located. The NT-TRP 176 belongs to the first set of NT-TRPs and the NT-TRP 172 belongs to the second set of NT-TRPs. Please note that the first set includes at least one NT-TRP and the second set includes at least one NT-TRP.

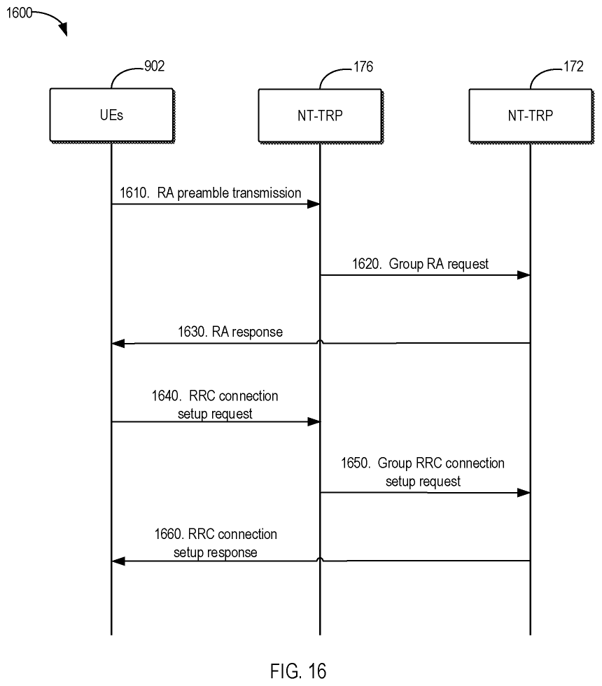

In this way, the NT-TRP 176 may act as a “collector” of RA requests transmitted by the UEs 902. The NT-TRP 176 transmits an RA message on behalf of those UEs 902 towards NT-TRP 172. The first stage of this RA procedure comprises that UEs 902 send e.g. RA preambles towards the NT-TRP 176. The second stage of this RA procedure comprises that NT-TRP 176 sends e.g. RA message towards NT-TRP 172 e.g. a satellite. This two-stage RA procedure may be summarized in a signaling chart shown in FIG. 16.

FIG. 16 illustrates a signaling chart illustrating an example process 1600 for two-stage RA in accordance with some implementations of the present disclosure. The process 1600 may be considered as an example implementation of the process 900. The process 1600 may involve the UEs 902 in FIG. 11, 12 or 13, the NT-TRP 172 in FIG. 13, and the NT-TRP 176 which is not shown in the previous figures.

As shown in FIG. 16, the UEs 902 transmits 1610 RA preambles to the NT-TRP 176.

Upon receiving the RA preambles from the UEs 902, the NT-TRP 176 transmits 1620, based on the received RA preambles, a group RA request to the NT-TRP 172. The group RA request indicates that the UEs 902 attempt to establish connections with the NT-TRP 172. Accordingly, the NT-TRP 172 receives the group RA request from the NT-TRP 176.

The NT-TRP 172 transmits 1630 an RA response to at least one of the UEs 902.

Similar to the implementation as shown in FIG. 15, the UEs 902 on the ground may transmit 1640 their RRC connection setup requests to the NT-TRP 176, which transmits 1650 a group RRC connection setup request to the NT-TRP 172.

Upon receiving the group RRC connection setup request from the NT-TRP 176, the NT-TRP 172 may transmit 1660 an RRC connection setup response to at least one of the UEs 902.

With the process 1600, a two-stage RA procedure may be achieved. There may be several benefits from using such a two-stage RA procedure. The benefit is similar to the benefit shown above. The first benefit is that it allows devices on the ground to transmit RA preambles towards devices that are closer to them and thus: reduce power consumption due to sending UL transmissions. The second benefit is that this RA scheme may reduce the probability of missed detection of RA preambles by NT-TRPs: NT-TRPs (i.e., the NT-TRP 176) located within a given coverage area and closer to the UEs 902 may transmit one RA message on behalf of e.g. several thousand devices, this may make it more feasible for NT-TRPs to process RA requests from devices on the ground and also initiate or establish e.g. RRC connections for these devices.

It shall be noted that the implementations of the RA preambles, the group RA request, the group configuration, the group RRC connection setup request described above with reference to FIGS. 11 to 15 are also applicable to the process 1600. Details of these implementations are omitted for brevity.

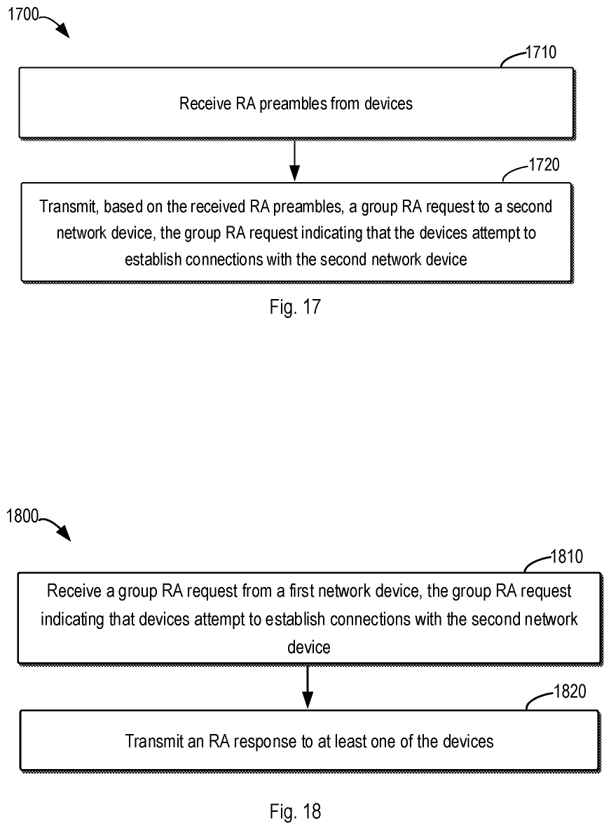

FIG. 17 illustrates an example of a method 1700 implemented at the first network device 904 in which some example implementations of the present disclosure may be implemented.

In some implementations, the first network device 904 may be included in a TN. In such implementations, the first network device 904 may be implemented as the T-TRP 170 in FIG. 1 or 2, or the T-TRP 540, 545, 550, 555, 560 or 565 in FIG. 5, or the T-TRP 630, 635, 640, 645, 650 or 655 in FIG. 6, or the T-TRP 740, 745, 750, 755, 760 or 765 in FIG. 7, or the T-TRP 825 in FIG. 8.

Alternatively, in some implementations, the first network device 904 may be included in an NTN. In such implementations, the first network device 904 may be implemented as the NT-TRP 172 in FIG. 2, or the NT-TRP 505, 510 or 515 in FIG. 5, or the NT-TRP 605, 610 or 615 in FIG. 6, or the NT-TRP 705, 710 or 715 in FIG. 7, or the NT-TRP 805 or 810 in FIG. 8.

As shown in FIG. 17, at 1710, the first network device 904 receives RA preambles from devices.

At 1720, the first network device 904 transmits, based on the received RA preambles, a group RA request to a second network device. The group RA request indicates that the devices attempt to establish connections with the second network device.

FIG. 18 illustrates an example of a method 1800 implemented at the second network device 906 in which some example implementations of the present disclosure may be implemented. In some implementations, the second network device 906 may be included in an NTN. In such implementations, the second network device 906 may be implemented as the NT-TRP 172 in FIG. 2, or the NT-TRP 505, 510 or 515 in FIG. 5, or the NT-TRP 605, 610 or 615 in FIG. 6, or the NT-TRP 705, 710 or 715 in FIG. 7, or the NT-TRP 805 or 810 in FIG. 8.

As shown in FIG. 18, at 1810, the second network device 906 receives a group RA request from a first network device. The group RA request indicates that devices attempt to establish connections between the second network device and devices.

At 1820, the second network device 906 transmits an RA response to at least one of the devices.

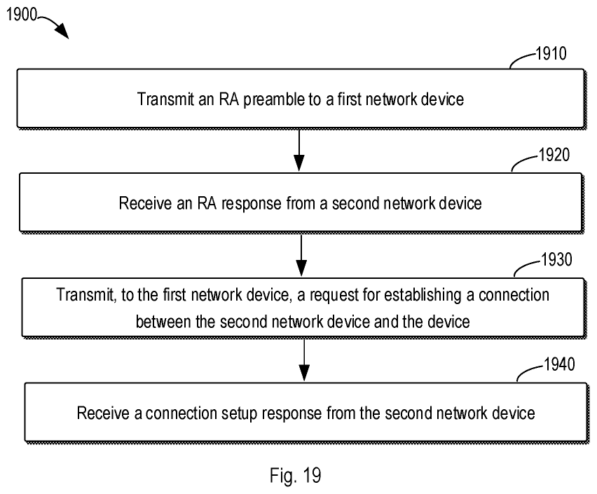

FIG. 19 illustrates an example of a method 1900 implemented at the device 902 in which some example implementations of the present disclosure may be implemented.

In some implementations, the devices 902 may be implemented as the EDs 110 in FIG. 1 or 2. For example, the devices 902 may be implemented as UEs, IoT devices, robots, or cars.

As shown in FIG. 19, at 1910, the device 902 transmits an RA preamble from a device to a first network device. The RA preamble is comprised in a first group of RA preambles which are associated with a non-terrestrial network.

At 1920, the device 902 receives an RA response from a second network device.

At 1930, the device 902 transmits, to the first network device, a request for establishing a connection between the second network device and the device.

At 1940, the device 902 receives a connection setup response from the second network device.

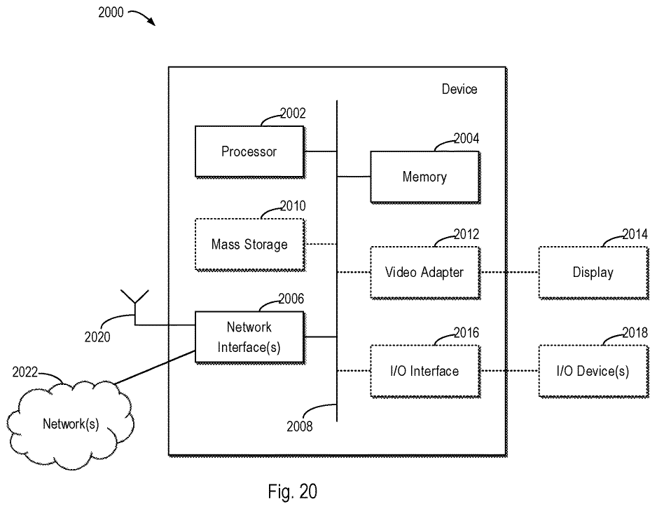

FIG. 20 is a block diagram of an electronic device (ED) 2000 that may be used for implementing devices, such as the device 902, the first network device 904, or the second network device 906 and methods such as 1700, 1800 or 1900 disclosed herein. In some embodiments, the device 2000 may be an element of communications network infrastructure, such as a base station (for example, a NodeB, an evolved Node B (eNodeB, or eNB), a next generation NodeB (sometimes referred to as a gNodeB or gNB), a home subscriber server (HSS), a gateway (GW) such as a packet gateway (PGW) or a serving gateway (SGW) or various other nodes or functions within a core network (CN) or a Public Land Mobility Network (PLMN). In other embodiments, the device 2000 may be a device that connects to the network infrastructure over a radio interface, such as a mobile phone, smart phone or other such device that may be classified as a User Equipment (UE). In some embodiments, the device 2000 may be a Machine Type Communications (MTC) device (also referred to as a machine-to-machine (M2M) device), or another such device that may be categorized as a UE despite not providing a direct service to a user. In some embodiments, the device 2000 may be a road side unit (RSU), a vehicle UE (V-UE), pedestrian UE (P-UE) or an infrastructure UE (I-UE). In some scenarios, the device 2000 may also be referred to as a mobile device, a term intended to reflect devices that connect to mobile network, regardless of whether the device itself is designed for, or capable of, mobility. Specific devices may utilize all of the components shown or only a subset of the components, and levels of integration may vary from device to device. Furthermore, the device 2000 may contain multiple instances of a component, such as multiple processors, memories, transmitters, receivers, etc.

The device 2000 typically includes a processor 2002, such as a Central Processing Unit (CPU), and may further include specialized processors such as a Graphics Processing Unit (GPU) or other such processor, a memory 2004, a network interface 2006 and a bus 2008 to connect the components of the device 2000. The device 2000 may optionally also include components such as a mass storage device 2010, a video adapter 2012, and an I/O interface 2016 (shown in dashed lines).

The memory 2004 may comprise any type of non-transitory system memory, readable by the processor 2002, such as static random access memory (SRAM), dynamic random access memory (DRAM), synchronous DRAM (SDRAM), read-only memory (ROM), or a combination thereof. In an embodiment, the memory 2004 may include more than one type of memory, such as ROM for use at boot-up, and DRAM for program and data storage for use while executing programs. The bus 2008 may be one or more of any type of several bus architectures including a memory bus or memory controller, a peripheral bus, or a video bus.

The device 2000 may also include one or more network interfaces 2006, which may include at least one of a wired network interface and a wireless network interface. As illustrated in FIG. 20, network interface 2006 may include a wired network interface to connect to a network 2022, and also may include a radio access network interface 2020 for connecting to other devices over a radio link. When the device 2000 is a network infrastructure element, the radio access network interface 2020 may be omitted for nodes or functions acting as elements of the PLMN other than those at the radio edge (e.g., an eNB). When the device 2000 is infrastructure at the radio edge of a network, both wired and wireless network interfaces may be included. When the device 2000 is a wirelessly connected device, such as a User Equipment, radio access network interface 2020 may be present and it may be supplemented by other wireless interfaces such as WiFi network interfaces. The network interfaces 2006 allow the device 2000 to communicate with remote entities such as those connected to network 2022.

The mass storage 2010 may comprise any type of non-transitory storage device configured to store data, programs, and other information and to make the data, programs, and other information accessible via the bus 2008. The mass storage 2010 may comprise, for example, one or more of a solid state drive, hard disk drive, a magnetic disk drive, or an optical disk drive. In some embodiments, the mass storage 2010 may be remote to the device 2000 and accessible through use of a network interface such as interface 2006. In the illustrated embodiment, the mass storage 2010 is distinct from memory 2004 where it is included, and may generally perform storage tasks compatible with higher latency, but may generally provide lesser or no volatility. In some embodiments, the mass storage 2010 may be integrated with a heterogeneous memory 2004.

The optional video adapter 2012 and the I/O interface 2016 (shown in dashed lines) provide interfaces to couple the device 2000 to external input and output devices. Examples of input and output devices include a display 2014 coupled to the video adapter 2012 and an I/O device 2018 such as a touch-screen coupled to the I/O interface 2016. Other devices may be coupled to the device 2000, and additional or fewer interfaces may be utilized. For example, a serial interface such as Universal Serial Bus (USB) (not shown) may be used to provide an interface for an external device. Those skilled in the art will appreciate that in embodiments in which the device 2000 is part of a data center, I/O interface 2016 and Video Adapter 2012 may be virtualized and provided through network interface 2006.

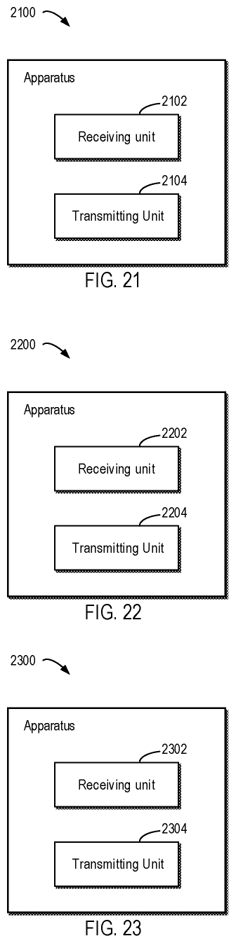

FIG. 21 is a schematic diagram of a structure of an apparatus 2100 in accordance with some implementations of the present disclosure. As shown in FIG. 21, the apparatus 2100 includes a receiving unit 2102 and a transmitting unit 2104. The apparatus 2100 may be applied to the communication system as shown in FIG. 1, and may implement any of the methods provided in the foregoing implementations. Optionally, a physical representation form of the apparatus 2100 may be a communication device, for example, the first network device 904. Alternatively, the apparatus 2100 may be another apparatus that can implement a function of a communication device, for example, a processor or a chip inside the communication device. Specifically, the apparatus 2100 may be some programmable chips such as a field-programmable gate array (field-programmable gate array, FPGA), a complex programmable logic device (complex programmable logic device, CPLD), an application-specific integrated circuit (application-specific integrated circuits, ASIC), or a system on a chip (System on a chip, SOC).

In some implementations, the receiving unit 2102 may be configured to receive RA preambles from devices. The transmitting unit 2104 may be configured to transmit, based on the received RA preambles, a group RA request to a second network device. The group RA request indicates that the devices attempt to establish connections with the second network device.

In some other implementations, the apparatus 2100 can include various other units or modules which may be configured to perform various operations or functions as described in connection with the foregoing method implementations. The details can be obtained referring to the detailed description of the foregoing method implementations and are not described herein again.

FIG. 22 is a schematic diagram of a structure of an apparatus 2200 in accordance with some implementations of the present disclosure. As shown in FIG. 22, the apparatus 2200 includes a receiving unit 2202 and a transmitting unit 2204. The apparatus 2200 may be applied to the communication system as shown in FIG. 1, and may implement any of the methods provided in the foregoing implementations. Optionally, a physical representation form of the apparatus 2200 may be a communication device, for example, the second network device 906. Alternatively, the apparatus 2200 may be another apparatus that can implement a function of a communication device, for example, a processor or a chip inside the communication device. Specifically, the apparatus 2200 may be some programmable chips such as a field-programmable gate array (field-programmable gate array, FPGA), a complex programmable logic device (complex programmable logic device, CPLD), an application-specific integrated circuit (application-specific integrated circuits, ASIC), or a system on a chip (System on a chip, SOC).

In some implementations, the receiving unit 2202 may be configured to receive a group RA request from a first network device. The group RA request indicates that devices attempt to establish connections with a second network device. The transmitting unit 2204 may be configured to transmit an RA response to at least one of the devices.

In some other implementations, the apparatus 2200 can include various other units or modules which may be configured to perform various operations or functions as described in connection with the foregoing method implementations. The details can be obtained referring to the detailed description of the foregoing method implementations and are not described herein again.

FIG. 23 is a schematic diagram of a structure of an apparatus 2300 in accordance with some implementations of the present disclosure. As shown in FIG. 23, the apparatus 2300 includes a receiving unit 2302 and a transmitting unit 2304. The apparatus 2300 may be applied to the communication system as shown in FIG. 1, and may implement any of the methods provided in the foregoing implementations. Optionally, a physical representation form of the apparatus 2300 may be a communication device, for example, the device 902. Alternatively, the apparatus 2300 may be another apparatus that can implement a function of a communication device, for example, a processor or a chip inside the communication device. Specifically, the apparatus 2300 may be some programmable chips such as a field-programmable gate array (field-programmable gate array, FPGA), a complex programmable logic device (complex programmable logic device, CPLD), an application-specific integrated circuit (application-specific integrated circuits, ASIC), or a system on a chip (System on a chip, SOC).

In some implementations, the receiving unit 2302 may be configured to transmit an RA preamble to a first network device. The RA preamble is comprised in a first group of RA preambles which are associated with a non-terrestrial network. The transmitting unit 2304 may be configured to receive an RA response from a second network device.

The receiving unit 2302 may be also configured to transmit, to the first network device, a request for establishing a connection with the second network device. The transmitting unit 2304 may be also configured to receive a connection setup response from the second network device.

In some other implementations, the apparatus 2300 can include various other units or modules which may be configured to perform various operations or functions as described in connection with the foregoing method implementations. The details can be obtained referring to the detailed description of the foregoing method implementations and are not described herein again.

It should be noted that division into the units or modules in the foregoing implementations of the present disclosure is an example, and is merely logical function division. In actual implementation, there may be another division manner. In addition, function units in implementations of the present disclosure may be integrated into one processing unit, or may exist alone physically, or two or more units may be integrated into one unit. The integrated unit may be implemented in a form of hardware, or may be implemented in a form of a software function unit.

When the integrated unit is implemented in a form of a software function unit and sold or used as an independent product, the integrated unit may be stored in a computer-readable storage medium. Based on such an understanding, the technical solutions of the present disclosure essentially, or all or some of the technical solutions may be implemented in a form of a software product. The computer software product is stored in a storage medium and includes several instructions for instructing a computer device (which may be a personal computer, a server, or a network device) or a processor (processor) to perform all or some of the steps of the methods described in implementations of the present disclosure. The foregoing storage medium includes any medium that can store program code, such as a USB flash drive, a removable hard disk, a read-only memory (Read-Only Memory, ROM), a random access memory (Random Access Memory, RAM), a magnetic disk, or an optical disc.

In some aspects of the present disclosure, there is provided an apparatus/chipset system comprising means (e.g., at least one processor) to implement a method implemented by (or at) a UE of the present disclosure. The apparatus/chipset system may be the UE (that is, a terminal device) or a module/component in the UE. In details, the at least one processor may execute instructions stored in a computer-readable medium to implement the method.

In some aspects of the present disclosure, there is provided an apparatus/chipset system comprising means (e.g., at least one processor) to implement the method implemented by (or at) a network device (e.g., base station) of the present disclosure. The apparatus/chipset system may be the network device or a module/component in the network device. In details, the at least one processor may execute instructions stored in a computer-readable medium to implement the method. In some aspects of the present disclosure, there is provided a system comprising at least one of an apparatus in (or at) a UE of the present disclosure, or an apparatus in (or at) a network device of the present disclosure.

In some aspects of the present disclosure, there is provided a method performed by a system comprising at least one of an apparatus in (or at) a UE of the present disclosure, and an apparatus in (or at) a network device of the present disclosure.

In some aspects of the present disclosure, there is provided a computer program comprising instructions. The instructions, when executed by a processor, may cause the processor to implement a method of the present disclosure.

In some aspects of the present disclosure, there is provided a non-transitory computer-readable medium storing instructions, the instructions, when executed by a processor, may cause the processor to implement a method of the present disclosure.

The solutions described in the disclosure is applicable to a next generation (e.g. sixth generation (6G) or later) network, or a legacy (e.g. 5G, 4G, 3G or 2G) network.

It will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

A person skilled in the art should understand that implementations of the present disclosure may be provided as a method, a system, or a computer program product. Therefore, the present disclosure may be in a form of a hardware-only embodiment, a software-only embodiment, or an embodiment combining software and hardware aspects. In addition, the present disclosure may be in a form of a computer program product implemented on one or more computer-usable storage media (including but not limited to a magnetic disk memory, a CD-ROM, an optical memory, and the like) including computer-usable program code.

The present disclosure is described with reference to the flowcharts and/or block diagrams of the method, the device (system), and the computer program product according to the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or a processor of another programmable data processing device generate an apparatus for implementing a specific function in one or more processes in the flowcharts and/or in one or more blocks in the block diagrams.

These computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may alternatively be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more processes in the flowcharts and/or in one or more blocks in the block diagrams.

It is clear that a person skilled in the art may make various modifications and variations to the present disclosure without departing from the protection scope of the present disclosure. Thus, the present disclosure is intended to cover these modifications and variations, provided that they fall within the scope of the claims of the present disclosure and their equivalent technologies.

Although this disclosure refers to illustrative implementations, this is not intended to be construed in a limiting sense. Various modifications and combinations of the illustrative implementations, as well as other implementations of the disclosure, will be apparent to persons skilled in the art upon reference to the description. When combining two or more implementations, not all the features in the implementations to be combined are necessary for the combination.

Features disclosed herein in the context of any particular implementations may also or instead be implemented in other implementations. Method implementations, for example, may also or instead be implemented in apparatus, system, and/or computer program product implementations. In addition, although implementations are described primarily in the context of methods and apparatus, other implementations are also contemplated, as instructions stored on one or more non-transitory computer-readable media, for example. Such media could store programming or instructions to perform any of various methods consistent with the present disclosure.

What is claimed is:

1. A method, comprising:
receiving, by a first network device, random access (RA) preambles from devices; and
transmitting, by the first network device based on the RA preambles, a group RA request to a second network device, the group RA request indicating that the devices attempt to establish connections with the second network device.

2. The method of claim 1, further comprising:
receiving, from the devices, requests for establishing the connections; and
transmitting a group connection setup request to the second network device, the group connection setup request comprising at least part of the requests received from the devices.

3. The method of claim 1, further comprising:
determining a first plurality of random access channel (RACH) identities (IDs) based on at least one physical random access channel (PRACH) occasion in which the RA preambles were received,
wherein the group RA request indicates the first plurality of RACH IDs.

4. The method of claim 1, wherein the group RA request indicates at least one of:
time when the RA preambles were received,
types of the devices,
whether a timing advance field is to be included in an RA response, wherein the RA response is to be received from the second network device,
whether a frequency hopping field is to be included in the RA response,
whether an uplink frequency resource allocation field is to be included in the RA response,
whether an uplink time resource allocation field is to be included in the RA response,
whether a modulation and coding scheme (MCS) field is to be included in the RA response,
whether a Transmit Power Control (TPC) command is to be included in the RA response,
whether a channel state information (CSI) request field is to be included in the RA response,
whether a channel access cyclic prefix (CP) extension field is to be included in the RA response,
whether an azimuth beam angle information (BAI) field is to be included in the RA response,
whether a zenith BAI field is to be included in the RA response, or
whether a temporary cell radio network temporary identifier (C-RNTI) field is to be included in the RA response.

5. The method of claim 1, further comprising:
obtaining a configuration for the group RA request.

6. The method of claim 5, wherein the configuration for the group RA request indicates at least one of:
a time window for reception of the RA preambles,
a period of the time window,
a length of sequences of the RA preambles,
time resources on which the RA preambles are to be received,
frequency resources on which the RA preambles are to be received,
whether time when the RA preambles were received is to be included in the group RA request,
whether types of the devices are to be included in the group RA request,
whether a timing advance request field is to be included in the group RA request,
whether a frequency hopping field is to be included in the group RA request,
whether an uplink frequency resource allocation field is to be included in the group RA request,
whether an uplink time resource allocation field is to be included in the group RA request,
whether an MCS field is to be included in the group RA request,
whether a TPC command is to be included in the group RA request,
whether a CSI request field is to be included in the group RA request,
whether a channel access CP extension field is to be included in the group RA request,
whether an azimuth BAI field is to be included in the group RA request,
whether a zenith BAI field is to be included in the group RA request, or
whether a temporary C-RNTI field is to be included in the group RA request.

7. The method of claim 2, wherein the group connection setup request comprises at least one of:
a second plurality of IDs of the devices, or
types of services that triggered establishment of the connections.

8. The method of claim 1, wherein the RA preambles are comprised in a first group of RA preambles associated with a non-terrestrial network.

9. A method, comprising:
receiving, by a second network device, a group random access (RA) request from a first network device, the group RA request indicating that devices attempt to establish connections with the second network device; and
transmitting an RA response to at least one of the devices.

10. The method of claim 9, further comprising:
receiving a group connection setup request from the first network device, the group connection setup request comprising at least part of requests for establishing the connections transmitted by the devices; and
transmitting a connection setup response to at least one of the devices.

11. The method of claim 9, wherein the group RA request comprises a first plurality of random access channel (RACH) identities (IDs) of the devices.

12. The method of claim 11, wherein the RA response comprises downlink control information scrambled with one of the first plurality of RACH IDs of the devices.

13. The method of claim 9, wherein the group RA request indicates at least one of:
time when RA preambles were received by the first network device,
types of the devices,
whether a timing advance field is to be included in the RA response,
whether a frequency hopping field is to be included in the RA response,
whether an uplink frequency resource allocation field is to be included in the RA response,
whether an uplink time resource allocation field is to be included in the RA response,
whether a modulation and coding scheme (MCS) field is to be included in the RA response,
whether a Transmit Power Control (TPC) command is to be included in the RA response,
whether a channel state information (CSI) request field is to be included in the RA response,
whether a channel access cyclic prefix (CP) extension field is to be included in the RA response,
whether an azimuth beam angle information (BAI) field is to be included in the RA response,
whether a zenith BAI field is to be included in the RA response, or
whether a temporary cell radio network temporary identifier (C-RNTI) field is to be included in the RA response.

14. The method of claim 9, further comprising:
transmitting, to the first network device, a configuration for the group RA request.

15. The method of claim 14, wherein the configuration for the group RA request indicates at least one of:
a time window for reception of RA preambles,
a period of the time window,
a length of sequences of the RA preambles,
time resources on which the RA preambles are to be received,
frequency resources on which the RA preambles are to be received,
whether time when the RA preambles were received is to be included in the group RA request,
whether types of the devices are to be included in the group RA request,
whether a timing advance request field is to be included in the group RA request,
whether a frequency hopping field is to be included in the group RA request,
whether an uplink frequency resource allocation field is to be included in the group RA request,
whether an uplink time resource allocation field is to be included in the group RA request,
whether an MCS field is to be included in the group RA request,
whether a TPC command is to be included in the group RA request,
whether a CSI request field is to be included in the group RA request,
whether a channel access CP extension field is to be included in the group RA request,
whether an azimuth BAI field is to be included in the group RA request,
whether a zenith BAI field is to be included in the group RA request, or
whether a temporary C-RNTI field is to be included in the group RA request.

16. The method of claim 10, wherein the group connection setup request comprises at least one of:
a second plurality of IDs of the devices, or
types of services that triggered establishment of the connections between the second network device and the devices.

17. A method, comprising:
transmitting, by a device, a random access (RA) preamble to a first network device, wherein the RA preamble is comprised in a first group of RA preambles which are associated with a non-terrestrial network;
receiving, by the device, an RA response from a second network device;
transmitting, by the device to the first network device, a request for establishing a connection with the second network device; and
receiving, by the device, a connection setup response from the second network device.

18. The method of claim 17, wherein the RA response comprises downlink control information scrambled with a first identity (ID) of the device, the first ID being associated with the RA preamble.

19. The method of claim 17, further comprising:
obtaining information about a beam direction for transmitting the RA preamble,
wherein the transmitting the RA preamble comprises transmitting the RA preamble based on the information.

20. The method of claim 19, wherein the information about the beam direction indicates at least one of:
an azimuth BAI, or
a zenith BAI.
